(19) United States
(12) Patent Application Publication
(10) Pub. No.: US 2026/0245218 A1
(43) Pub. Date: Aug. 20, 2026

(54) ACTION SEGMENTATION WITH SHARED-PRIVATE REPRESENTATION OF MULTIPLE DATA SOURCES

(71) Applicant: DIGITAL SURGERY LIMITED, London (GB)

(72) Inventors: Abdolrahim Kadkhodamohammadi, London (GB); Beatrice Margherita Johanna van Amsterdam, London (GB); Imanol Luengo Muntion, London (GB); Danail V. Stoyanov, London (GB)

(21) Appl. No.: 19/128,401

(22) PCT Filed: Nov. 10, 2023
(86) PCT No.: PCT/EP2023/081520

§ 371 Date: May 8, 2025

Related U.S. Application Data
(60) Provisional application No. 63/424,280, filed on Nov. 10, 2022.
(60) Provisional application No. 63/499,003, filed on Apr. 28, 2023.

(51) Int. Cl. G06T 7/215; G06N 3/0455

(52) U.S. Cl. CPC G06T 7/215; G06N 3/0455

(57) ABSTRACT

Examples described herein provide a computer-implemented method that includes processing streams of input signals received from the respective data sources, each containing shared and private representations related to captured actions, which includes disentangling the shared and private representations from the streams of input signals to derive disentangled feature sequences, processing the disentangled feature sequences, each containing private representations and shared representations, with a plurality of encoders, wherein the processing includes using a temporal attention bottleneck to preserve feature disentanglement in consecutive encoder layers; generating, from the processed disentangled feature sequences, frame-wise action predictions by concatenating the shared bottleneck and private representations in the last encoder layer to thereby generate the action predictions; and refining the predictions with attention-based decoders.

### BACKGROUND

The present disclosure relates in general to computing technology and relates more particularly to computing technology for executing action segmentation with shared-private representation of multiple data sources.

Computer-assisted systems, particularly computer-assisted surgery systems (CASs), rely on video data digitally captured during a surgery. Such video data can be stored and/or streamed. In some cases, the video data can be used to augment a person's physical sensing, perception, and reaction capabilities. For example, such systems can effectively provide the information corresponding to an expanded field of vision, both temporal and spatial, that enables a person to adjust current and future actions based on the part of an environment not included in his or her physical field of view. Alternatively, or in addition, the video data can be stored and/or transmitted for several purposes, such as archival, training, post-surgery analysis, and/or patient consultation.

Most state-of-the-art methods for action segmentation are based on single input modalities or native fusion of multiple data sources. However, effective fusion of complementary information can potentially strengthen segmentation models and make them more robust to sensor noise and more accurate with smaller training datasets.

### SUMMARY

According to an aspect, disclosed is a computer-implemented method of partitioning latent representations of multimodal networks into a shared space containing common information across data sources, and a private space for each of the modalities, the method including: processing streams of input signals received from the respective data sources, each containing shared representations and private representations related to captured actions, which includes disentangling the shared representations and private representations from the streams of input signals to derive disentangled feature sequences; processing the disentangled feature sequences, each containing private representations and shared representations, with a plurality of encoders, wherein the processing includes using a temporal attention bottleneck to preserve feature disentanglement in consecutive encoder layers generating, from the processed disentangled feature sequences, frame-wise action predictions by concatenating the shared bottleneck and private representations in the last encoder layer to thereby generate the action predictions; and refining the predictions with attention-based decoders.

According to another aspect, disclosed is a system including: a data store including video data associated with a surgical procedure; and a machine learning training system configured to partition latent representations of multimodal networks into a shared space containing common information across the data sources, and a private space for each of the modalities, the wherein the system is configured for executing operations, including: processing streams of input signals received from the respective data sources, each containing shared representations and private representations related to captured actions, which includes disentangling the shared representations and private representations from the streams of input signals to derive disentangled feature sequences; processing the disentangled feature sequences, each containing private representations and shared representations, with a plurality of encoders, wherein the processing includes using a temporal attention bottleneck to preserve feature disentanglement in consecutive encoder layers; generating, from the processed disentangled feature sequences, frame-wise action predictions; and refining the predictions with attention-based decoders.

According to another aspect, disclosed is a computer program product including a memory device having computer executable instructions stored thereon, which when executed by one or more processors cause the one or more processors to perform a plurality of operations including: partitioning latent representations of multimodal networks into a shared space containing common information across the data sources, and a private space for each of the modalities, the which includes: processing streams of input signals received from the respective data sources, each containing shared representations and private representations related to captured actions, which includes disentangling the shared representations and private representations from the streams of input signals to derive disentangled feature sequences; processing the disentangled feature sequences, each containing private representations and shared representations, with a plurality of encoders; generating, from the processed disentangled feature sequences, frame-wise action predictions; and refining the predictions with attention-based decoders.

The above features and advantages, and other features and advantages, of the disclosure are readily apparent from the following detailed description when taken in connection with the accompanying drawings.

### BRIEF DESCRIPTION OF THE DRAWINGS

The specifics of the exclusive rights described herein are particularly pointed out and distinctly claimed in the claims at the conclusion of the specification. The foregoing and other features and advantages of the aspects of the disclosure are apparent from the following detailed description taken in conjunction with the accompanying drawings in which:

FIG. 1 depicts a computer-assisted surgery (CAS) system according to one or more aspects;

FIG. 2 depicts a surgical procedure system according to one or more aspects;

FIG. 3 depicts a system for analyzing video and data according to one or more aspects;

FIG. 4 shows different paradigms for multi-source data fusion according to one or more aspects;

FIG. 5 depicts an ASPnet schematic according to according to one or more aspects;

FIG. 6 depicts qualitative results of utilizing the disclosed process on a data set according to one or more aspects;

FIG. 7(a) depicts ASPnet robustness to noise according to one or more aspects;

FIG. 7(b) depicts an impact of reducing the training set size on different models according to one or more aspects;

FIG. 8a depicts a flowchart of a method of partitioning latent representations of multimodal networks into a shared space containing common information across data sources, and a private space for each of the modalities according to one or more aspects;

FIG. 8b depicts another flowchart of a method of executing a first stage of the method of FIG. 8a according to one or more aspects;

FIG. 8c depicts another flowchart of a method of executing a second stage of the method of FIG. 8a according to one or more aspects;

FIG. 8d depicts another flowchart of a method of generating frame-wise action predictions under the method of FIG. 8a according to one or more aspects;

FIG. 8e depicts another flowchart of a method of applying auxiliary losses under the method of FIG. 8a according to one or more aspects; and

FIG. 9 depicts a block diagram of a computer system according to one or more aspects.

The diagrams depicted herein are illustrative. There can be many variations to the diagrams and/or the operations described herein without departing from the spirit of the described aspects. For instance, the actions can be performed in a differing order, or actions can be added, deleted, or modified. Also, the term “coupled” and variations thereof describe having a communications path between two elements and do not imply a direct connection between the elements with no intervening elements/connections between them. All of these variations are considered a part of the specification.

### DETAILED DESCRIPTION

Exemplary aspects of the technical solutions described herein include systems and methods for executing action segmentation with shared-private representation of multiple data sources.

In machine learning, modality refers to the different types of data that can be used as input for a model. For example, multimodal learning attempts to model the combination of different modalities of data, often arising in real-world applications. An example of multi-modal data is data that combines text (typically represented as discrete word count vectors) with imaging data consisting of pixel intensities and annotation tags. Separate modalities may include motion captured by accelerometers, video and voice captured by motion and audio sensors, etc., as nonlimiting examples. Modalities may also include derived or extracted input from one or more data streams.

To improve multimodal representation learning for action segmentation, the disclosed model disentangles features of a multi-stream segmentation model into modality-shared components, containing common information across data sources, and private components; the disclosed model uses an attention bottleneck to capture long-range temporal dependencies in the data while preserving disentanglement in consecutive processing layers. Evaluation on three commonly available datasets, including the 50salads dataset, the Breakfast Actions dataset and the RARP45 dataset, shows that the disclosed multimodal approach outperforms different data fusion baselines on both multiview and multimodal data sources. The disclosed model is also more robust to additive sensor noise and can achieve performance on par with video baselines with less training data.

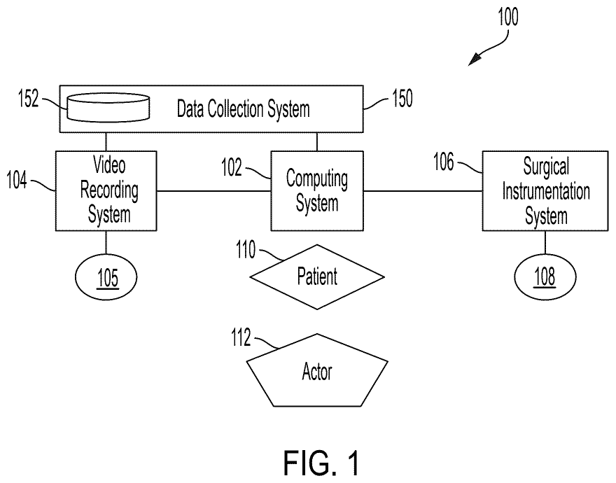

Turning now to FIG. 1, an example computer-assisted system (CAS) system 100 is generally shown in accordance with one or more aspects. The CAS system 100 includes at least a computing system 102, a video recording system 104, and a surgical instrumentation system 106. As illustrated in FIG. 1, an actor 112 can be medical personnel that uses the CAS system 100 to perform a surgical procedure on a patient 110. Medical personnel can be a surgeon, assistant, nurse, administrator, or any other actor that interacts with the CAS system 100 in a surgical environment. The surgical procedure can be any type of surgery, such as but not limited to cataract surgery, laparoscopic cholecystectomy, endoscopic endonasal transsphenoidal approach (eTSA) to resection of pituitary adenomas, or any other surgical procedure. In other examples, actor 112 can be a technician, an administrator, an engineer, or any other such personnel that interacts with the CAS system 100. For example, actor 112 can record data from the CAS system 100, configure/update one or more attributes of the CAS system 100, review past performance of the CAS system 100, repair the CAS system 100, and/or the like including combinations and/or multiples thereof.

A surgical procedure can include multiple phases, and each phase can include one or more surgical actions. A “surgical action” can include an incision, a compression, a stapling, a clipping, a suturing, a cauterization, a sealing, or any other such actions performed to complete a phase in the surgical procedure. A “phase” represents a surgical event that is composed of a series of steps (e.g., closure). A “step” refers to the completion of a named surgical objective (e.g., hemostasis). During each step, certain surgical instruments 108 (e.g., forceps) are used to achieve a specific objective by performing one or more surgical actions. In addition, a particular anatomical structure of the patient may be the target of the surgical action(s).

The video recording system 104 includes one or more cameras 105, such as operating room cameras, endoscopic cameras, and/or the like including combinations and/or multiples thereof. The cameras 105 capture video data of the surgical procedure being performed. The video recording system 104 includes one or more video capture devices that can include cameras 105 placed in the surgical room to capture events surrounding (i.e., outside) the patient being operated upon. The video recording system 104 further includes cameras 105 that are passed inside (e.g., endoscopic cameras) the patient 110 to capture endoscopic data. The endoscopic data provides video and images of the surgical procedure.

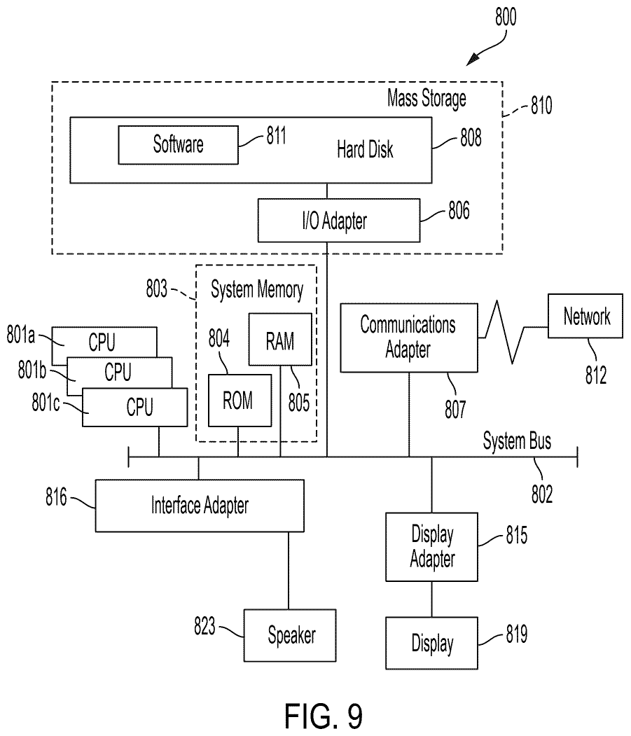

The computing system 102 includes one or more memory devices, one or more processors, a user interface device, among other components. All or a portion of the computing system 102 shown in FIG. 1 can be implemented for example, by all or a portion of computer system 800 of FIG. 9. Computing system 102 can execute one or more computer-executable instructions. The execution of the instructions facilitates the computing system 102 to perform one or more methods, including those described herein. The computing system 102 can communicate with other computing systems via a wired and/or a wireless network. In one or more examples, the computing system 102 includes one or more trained machine learning models that can detect and/or predict features of/from the surgical procedure that is being performed or has been performed earlier. Features can include structures, such as anatomical structures, surgical instruments 108 in the captured video of the surgical procedure. Features can further include events, such as phases and/or actions in the surgical procedure. Features that are detected can further include the actor 112 and/or patient 110. Based on the detection, the computing system 102, in one or more examples, can provide recommendations for subsequent actions to be taken by the actor 112. Alternatively, or in addition, the computing system 102 can provide one or more reports based on the detections. The detections by the machine learning models can be performed in an autonomous or semi-autonomous manner.

The machine learning models can include artificial neural networks, such as deep neural networks, convolutional neural networks, recurrent neural networks, vision transformers, encoders, decoders, or any other type of machine learning model. The machine learning models can be trained in a supervised, unsupervised, or hybrid manner. The machine learning models can be trained to perform detection and/or prediction using one or more types of data acquired by the CAS system 100. For example, the machine learning models can use the video data captured via the video recording system 104. Alternatively, or in addition, the machine learning models use the surgical instrumentation data from the surgical instrumentation system 106. In yet other examples, the machine learning models use a combination of video data and surgical instrumentation data.

Additionally, in some examples, the machine learning models can also use audio data captured during the surgical procedure. The audio data can include sounds emitted by the surgical instrumentation system 106 while activating one or more surgical instruments 108. Alternatively, or in addition, the audio data can include voice commands, snippets, or dialog from one or more actors 112. The audio data can further include sounds made by the surgical instruments 108 during their use.

In one or more examples, the machine learning models can detect surgical actions, surgical phases, anatomical structures, surgical instruments, and various other features from the data associated with a surgical procedure. The detection can be performed in real-time in some examples. Alternatively, or in addition, the computing system 102 analyzes the surgical data, i.e., the various types of data captured during the surgical procedure, in an offline manner (e.g., post-surgery). In one or more examples, the machine learning models detect surgical phases based on detecting some of the features, such as the anatomical structure, surgical instruments, and/or the like including combinations and/or multiples thereof.

A data collection system 150 can be employed to store the surgical data, including the video(s) captured during the surgical procedures. The data collection system 150 includes one or more storage devices 152. The data collection system 150 can be a local storage system, a cloud-based storage system, or a combination thereof. Further, the data collection system 150 can use any type of cloud-based storage architecture, for example, public cloud, private cloud, hybrid cloud, and/or the like including combinations and/or multiples thereof. In some examples, the data collection system can use a distributed storage, i.e., the storage devices 152 are located at different geographic locations. The storage devices 152 can include any type of electronic data storage media used for recording machine-readable data, such as semiconductor-based, magnetic-based, optical-based storage media, and/or the like including combinations and/or multiples thereof. For example, the data storage media can include flash-based solid-state drives (SSDs), magnetic-based hard disk drives, magnetic tape, optical discs, and/or the like including combinations and/or multiples thereof.

In one or more examples, the data collection system 150 can be part of the video recording system 104, or vice-versa. In some examples, the data collection system 150, the video recording system 104, and the computing system 102, can communicate with each other via a communication network, which can be wired, wireless, or a combination thereof. The communication between the systems can include the transfer of data (e.g., video data, instrumentation data, and/or the like including combinations and/or multiples thereof), data manipulation commands (e.g., browse, copy, paste, move, delete, create, compress, and/or the like including combinations and/or multiples thereof), data manipulation results, and/or the like including combinations and/or multiples thereof. In one or more examples, the computing system 102 can manipulate the data already stored/being stored in the data collection system 150 based on outputs from the one or more machine learning models (e.g., phase detection, anatomical structure detection, surgical tool detection, and/or the like including combinations and/or multiples thereof). Alternatively, or in addition, the computing system 102 can manipulate the data already stored/being stored in the data collection system 150 based on information from the surgical instrumentation system 106.

In one or more examples, the video captured by the video recording system 104 is stored on the data collection system 150. In some examples, the computing system 102 curates parts of the video data being stored on the data collection system 150. In some examples, the computing system 102 filters the video captured by the video recording system 104 before it is stored on the data collection system 150. Alternatively, or in addition, the computing system 102 filters the video captured by the video recording system 104 after it is stored on the data collection system 150.

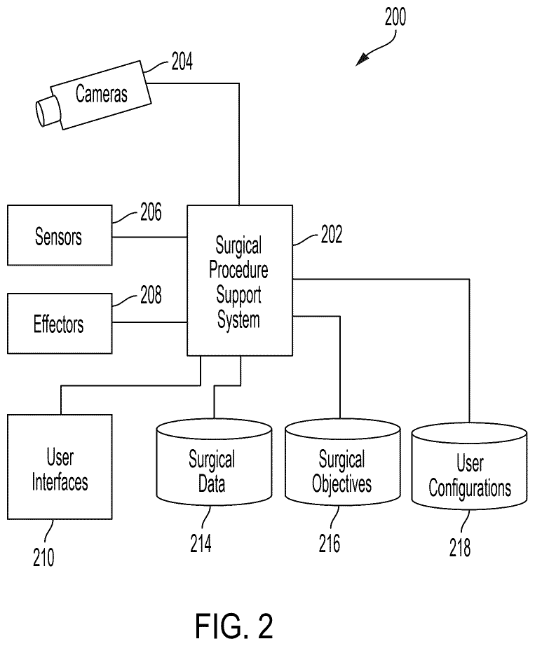

Turning now to FIG. 2, a surgical procedure system 200 is generally shown according to one or more aspects. The example of FIG. 2 depicts a surgical procedure support system 202 that can include or may be coupled to the CAS system 100 of FIG. 1. The surgical procedure support system 202 can acquire image or video data using one or more cameras 204. The surgical procedure support system 202 can also interface with one or more sensors 206 and/or one or more effectors 208. The sensors 206 may be associated with surgical support equipment and/or patient monitoring. The effectors 208 can be robotic components or other equipment controllable through the surgical procedure support system 202. The surgical procedure support system 202 can also interact with one or more user interfaces 210, such as various input and/or output devices. The surgical procedure support system 202 can store, access, and/or update surgical data 214 associated with a training dataset and/or live data as a surgical procedure is being performed on patient 110 of FIG. 1. The surgical procedure support system 202 can store, access, and/or update surgical objectives 216 to assist in training and guidance for one or more surgical procedures. User configurations 218 can track and store user preferences.

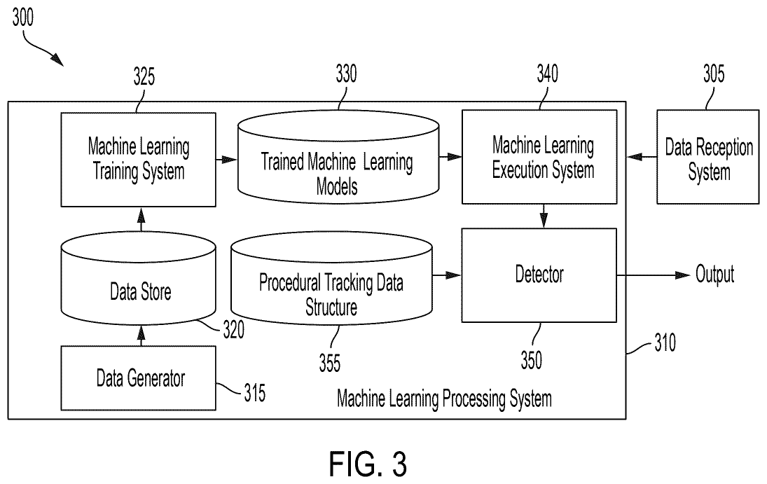

Turning now to FIG. 3, a system 300 for analyzing video and data is generally shown according to one or more aspects. In accordance with aspects, the video and data is captured from video recording system 104 of FIG. 1. The analysis can result in predicting features that include surgical phases and structures (e.g., instruments, anatomical structures, and/or the like including combinations and/or multiples thereof) in the video data using machine learning. System 300 can be the computing system 102 of FIG. 1, or a part thereof in one or more examples. System 300 uses data streams in the surgical data to identify procedural states according to some aspects.

System 300 includes a data reception system 305 that collects surgical data, including the video data and surgical instrumentation data. The data reception system 305 can include one or more devices (e.g., one or more user devices and/or servers) located within and/or associated with a surgical operating room and/or control center. The data reception system 305 can receive surgical data in real-time, i.e., as the surgical procedure is being performed. Alternatively, or in addition, the data reception system 305 can receive or access surgical data in an offline manner, for example, by accessing data that is stored in the data collection system 150 of FIG. 1.

System 300 further includes a machine learning processing system 310 that processes the surgical data using one or more machine learning models to identify one or more features, such as surgical phase, instrument, anatomical structure, and/or the like including combinations and/or multiples thereof, in the surgical data. It will be appreciated that machine learning processing system 310 can include one or more devices (e.g., one or more servers), each of which can be configured to include part or all of one or more of the depicted components of the machine learning processing system 310. In some instances, a part or all of the machine learning processing system 310 is cloud-based and/or remote from an operating room and/or physical location corresponding to a part or all of data reception system 305. It will be appreciated that several components of the machine learning processing system 310 are depicted and described herein. However, the components are just one example structure of the machine learning processing system 310, and that in other examples, the machine learning processing system 310 can be structured using a different combination of the components. Such variations in the combination of the components are encompassed by the technical solutions described herein.

The machine learning processing system 310 includes a machine learning training system 325, which can be a separate device (e.g., server) that stores its output as one or more trained machine learning models 330. The machine learning models 330 are accessible by a machine learning execution system 340. The machine learning execution system 340 can be separate from the machine learning training system 325 in some examples. In other words, in some aspects, devices that “train” the models are separate from devices that “infer,” i.e., perform real-time processing of surgical data using the trained machine learning models 330.

Machine learning processing system 310, in some examples, further includes a data generator 315 to generate simulated surgical data, such as a set of synthetic images and/or synthetic video, in combination with real image and video data from the video recording system 104, to generate trained machine learning models 330. Data generator 315 can access (read/write) a data store 320 to record data, including multiple images and/or multiple videos. The images and/or videos can include images and/or videos collected during one or more procedures (e.g., one or more surgical procedures). For example, the images and/or video may have been collected by a user device worn by the actor 112 of FIG. 1 (e.g., surgeon, surgical nurse, anesthesiologist, and/or the like including combinations and/or multiples thereof) during the surgery, a non-wearable imaging device located within an operating room, an endoscopic camera inserted inside the patient 110 of FIG. 1, and/or the like including combinations and/or multiples thereof. The data store 320 is separate from the data collection system 150 of FIG. 1 in some examples. In other examples, the data store 320 is part of the data collection system 150.

Each of the images and/or videos recorded in the data store 320 for performing training (e.g., generating the machine learning models 330) can be defined as a base image and can be associated with other data that characterizes an associated procedure and/or rendering specifications. For example, the other data can identify a type of procedure, a location of a procedure, one or more people involved in performing the procedure, surgical objectives, and/or an outcome of the procedure. Alternatively, or in addition, the other data can indicate a stage of the procedure with which the image or video corresponds, rendering specification with which the image or video corresponds and/or a type of imaging device that captured the image or video (e.g., and/or, if the device is a wearable device, a role of a particular person wearing the device, and/or the like including combinations and/or multiples thereof). Further, the other data can include image-segmentation data that identifies and/or characterizes one or more objects (e.g., tools, anatomical objects, and/or the like including combinations and/or multiples thereof) that are depicted in the image or video. The characterization can indicate the position, orientation, or pose of the object in the image. For example, the characterization can indicate a set of pixels that correspond to the object and/or a state of the object resulting from a past or current user handling. Localization can be performed using a variety of techniques for identifying objects in one or more coordinate systems.

The machine learning training system 325 uses the recorded data in the data store 320, which can include the simulated surgical data (e.g., set of synthetic images and/or synthetic video) and/or actual surgical data to generate the trained machine learning models 330. The trained machine learning models 330 can be defined based on a type of model and a set of hyperparameters (e.g., defined based on input from a client device). The trained machine learning models 330 can be configured based on a set of parameters that can be dynamically defined based on (e.g., continuous or repeated) training (i.e., learning, parameter tuning). Machine learning training system 325 can use one or more optimization algorithms to define the set of parameters to minimize or maximize one or more loss functions. The set of (learned) parameters can be stored as part of the trained machine learning models 330 using a specific data structure for a particular trained machine learning model of the trained machine learning models 330. The data structure can also include one or more non-learnable variables (e.g., hyperparameters and/or model definitions).

Machine learning execution system 340 can access the data structure(s) of the trained machine learning models 330 and accordingly configure the trained machine learning models 330 for inference (e.g., prediction, classification, and/or the like including combinations and/or multiples thereof). The trained machine learning models 330 can include, for example, a fully convolutional network adaptation, an adversarial network model, an encoder, a decoder, or other types of machine learning models. The type of the trained machine learning models 330 can be indicated in the corresponding data structures. The trained machine learning models 330 can be configured in accordance with one or more hyperparameters and the set of learned parameters.

The trained machine learning models 330, during execution, receive, as input, surgical data to be processed and subsequently generate one or more inferences according to the training. For example, the video data captured by the video recording system 104 of FIG. 1 can include data streams (e.g., an array of intensity, depth, and/or RGB values) for a single image or for each of a set of frames (e.g., including multiple images or an image with sequencing data) representing a temporal window of fixed or variable length in a video. The video data that is captured by the video recording system 104 can be received by the data reception system 305, which can include one or more devices located within an operating room where the surgical procedure is being performed. Alternatively, the data reception system 305 can include devices that are located remotely, to which the captured video data is streamed live during the performance of the surgical procedure. Alternatively, or in addition, the data reception system 305 accesses the data in an offline manner from the data collection system 150 or from any other data source (e.g., local or remote storage device).

The data reception system 305 can process the video and/or data received. The processing can include decoding when a video stream is received in an encoded format such that data for a sequence of images can be extracted and processed. The data reception system 305 can also process other types of data included in the input surgical data. For example, the surgical data can include additional data streams, such as audio data, RFID data, textual data, measurements from one or more surgical instruments/sensors, and/or the like including combinations and/or multiples thereof, that can represent stimuli/procedural states from the operating room. The data reception system 305 synchronizes the different inputs from the different devices/sensors before inputting them in the machine learning processing system 310.

The trained machine learning models 330, once trained, can analyze the input surgical data, and in one or more aspects, predict and/or characterize features (e.g., structures) included in the video data included with the surgical data. The video data can include sequential images and/or encoded video data (e.g., using digital video file/stream formats and/or codecs, such as MP4, MOV, AVI, WEBM, AVCHD, OGG, and/or the like including combinations and/or multiples thereof). The prediction and/or characterization of the features can include segmenting the video data or predicting the localization of the structures with a probabilistic heatmap. In some instances, the one or more trained machine learning models 330 include or are associated with a preprocessing or augmentation (e.g., intensity normalization, resizing, cropping, and/or the like including combinations and/or multiples thereof) that is performed prior to segmenting the video data. An output of the one or more trained machine learning models 330 can include image-segmentation or probabilistic heatmap data that indicates which (if any) of a defined set of structures are predicted within the video data, a location and/or position and/or pose of the structure(s) within the video data, and/or state of the structure(s). The location can be a set of coordinates in an image/frame in the video data. For example, the coordinates can provide a bounding box. The coordinates can provide boundaries that surround the structure(s) being predicted. The trained machine learning models 330, in one or more examples, are trained to perform higher-level predictions and tracking, such as predicting a phase of a surgical procedure and tracking one or more surgical instruments used in the surgical procedure.

While some techniques for predicting a surgical phase (“phase”) in the surgical procedure are described herein, it should be understood that any other technique for phase prediction can be used without affecting the aspects of the technical solutions described herein. In some examples, the machine learning processing system 310 includes a detector 350 that uses the trained machine learning models 330 to identify various items or states within the surgical procedure (“procedure”). The detector 350 can use a particular procedural tracking data structure 355 from a list of procedural tracking data structures. The detector 350 can select the procedural tracking data structure 355 based on the type of surgical procedure that is being performed. In one or more examples, the type of surgical procedure can be predetermined or input by actor 112. For instance, the procedural tracking data structure 355 can identify a set of potential phases that can correspond to a part of the specific type of procedure as “phase predictions”, where the detector 350 is a phase detector.

In some examples, the procedural tracking data structure 355 can be a graph that includes a set of nodes and a set of edges, with each node corresponding to a potential phase. The edges can provide directional connections between nodes that indicate (via the direction) an expected order during which the phases will be encountered throughout an iteration of the procedure. The procedural tracking data structure 355 may include one or more branching nodes that feed to multiple next nodes and/or can include one or more points of divergence and/or convergence between the nodes. In some instances, a phase indicates a procedural action (e.g., surgical action) that is being performed or has been performed and/or indicates a combination of actions that have been performed. In some instances, a phase relates to a biological state of a patient undergoing a surgical procedure. For example, the biological state can indicate a complication (e.g., blood clots, clogged arteries/veins, and/or the like including combinations and/or multiples thereof), pre-condition (e.g., lesions, polyps, and/or the like including combinations and/or multiples thereof). In some examples, the trained machine learning models 330 are trained to detect an “abnormal condition,” such as hemorrhaging, arrhythmias, blood vessel abnormality, and/or the like including combinations and/or multiples thereof.

Each node within the procedural tracking data structure 355 can identify one or more characteristics of the phase corresponding to that node. The characteristics can include visual characteristics. In some instances, the node identifies one or more tools that are typically in use or available for use (e.g., on a tool tray) during the phase. The node also identifies one or more roles of people who are typically performing a surgical task, a typical type of movement (e.g., of a hand or tool), and/or the like including combinations and/or multiples thereof. Thus, detector 350 can use the segmented data generated by machine learning execution system 340 that indicates the presence and/or characteristics of particular objects within a field of view to identify an estimated node to which the real image data corresponds. Identification of the node (i.e., phase) can further be based upon previously detected phases for a given procedural iteration and/or other detected input (e.g., verbal audio data that includes person-to-person requests or comments, explicit identifications of a current or past phase, information requests, and/or the like including combinations and/or multiples thereof).

The detector 350 can output predictions, such as a phase prediction associated with a portion of the video data that is analyzed by the machine learning processing system 310. The phase prediction is associated with the portion of the video data by identifying a start time and an end time of the portion of the video that is analyzed by the machine learning execution system 340. The phase prediction that is output can include segments of the video where each segment corresponds to and includes an identity of a surgical phase as detected by the detector 350 based on the output of the machine learning execution system 340. Further, the phase prediction, in one or more examples, can include additional data dimensions, such as, but not limited to, identities of the structures (e.g., instrument, anatomy, and/or the like including combinations and/or multiples thereof) that are identified by the machine learning execution system 340 in the portion of the video that is analyzed. The phase prediction can also include a confidence score of the prediction. Other examples can include various other types of information in the phase prediction that is output. Further, other types of outputs of the detector 350 can include state information or other information used to generate audio output, visual output, and/or commands. For instance, the output can trigger an alert, an augmented visualization, identify a predicted current condition, identify a predicted future condition, command control of equipment, and/or result in other such data/commands being transmitted to a support system component, e.g., through surgical procedure support system 202 of FIG. 2.

It should be noted that although some of the drawings depict endoscopic videos being analyzed, the technical solutions described herein can be applied to analyze video and image data captured by cameras that are not endoscopic (i.e., cameras external to the patient's body) when performing open surgeries (i.e., not laparoscopic surgeries). For example, the video and image data can be captured by cameras that are mounted on one or more personnel in the operating room (e.g., surgeon). Alternatively, or in addition, the cameras can be mounted on surgical instruments, walls, or other locations in the operating room. Alternatively, or in addition, the video can be images captured by other imaging modalities, such as ultrasound.

Action segmentation is the task of predicting which action is occurring at each frame in untrimmed videos of complex and semantically structured human activities. While conventional methods for human action understanding focus on classification of short video clips, action segmentation models learn the semantics of action classes as well as their temporal boundaries and contextual relations, which is challenging and requires the design of efficient strategies to capture long range temporal information and interaction correlations.

Known methods for action segmentation input precomputed low-dimensional visual features into different long-range temporal processing units, such as temporal convolutions, temporal self-attention or graph neural networks. While these methods utilize only video data, known computer vision datasets have increasing availability of multiple synchronized data sources, some of which could be collected readily in real case scenarios (e.g., audio recordings, teleoperated robot kinematics, and the like). Effective fusion of different data modalities or different ‘views’ of the same modality (the term ‘view’ denotes any different representation of the same data source) is not trivial, as potential advantages include higher recognition performance, improved robustness to sensor noise and mitigating the need for large training datasets.

Action segmentation with multiple data sources has not been investigated as exten-sively as similar tasks like action classification. It has generally been addressed via native fusion strategies such as multimodal feature concatenation and prediction fusion, or limited to the feature encoding stage. However, sensor fusion can also benefit from long-range temporal modelling performed in later stages.

The disclosed aspects implement a multi-stream action segmentation model, one stream for each available data source, and disentangling their latent space into modality-shared versus modality-specific representations, aiming at learning more discriminative features and more robust action recognition. Creating a shared feature space across data sources produces more abstract action representations and reduces over-fitting to modality-specific nuances and noise, while private features retain useful complementary information for the downstream task. Instead of relying on adversarial mechanisms, autoencoders or generative approaches, the disclosed model learns shared feature spaces with minimal model modification by minimizing Maximum Mean Discrepancy (MMD) on partitions of the latent spaces to reduce the distance between their distributions. In order to capture long-range temporal dependencies in the data while preserving feature disentanglement in consecutive processing layers, an attention bottleneck is then integrated into the segmentation model and initialized with learned modality-shared features, allowing independent processing of all private features. The disclosed model is alternatively referred to herein as ASPnet (Action Shared-Private network).

Evaluation results of the disclosed model on three challenging benchmark datasets show improvement over unimodal baselines and different fusion strategies using both multimodal (e.g., video and accelerometer) and multi-view (e.g., RGB and optical flow) inputs. In addition, results suggest that ASPnet could generalize well to multiple data sources, improving its performance with growing number of inputs. Despite requiring synchronized recordings of multiple sensors, the disclosed model that is also more robust to additive input noise and can match the performance of strong video baselines with less data. In summary, the disclosed model provides the following: ASPnet, is a multi-source activity recognition model to effectively exploit shared and complementary information contained in multiple data sources for robust action segmentation. ASPnet partitions the latent representation of each modality and exploits a bottleneck mechanism to allow feature interaction at multiple levels of abstraction while preserving disentanglement. Additionally, modality fusion is influenced by long-range temporal dynamics captured at different scales. An advantage of the disclosed model is feature disentanglement to fuse not only multimodal data, but also multiple representations of the same modality.

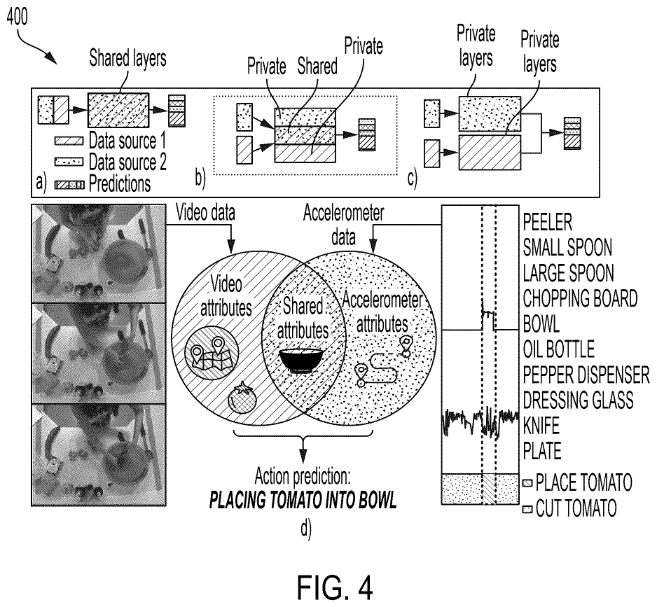

Turning to FIG. 4, different paradigms 400 are shown for multi-source data fusion via (a) early fusion, (b) disentanglement of modality-shared and modality-specific representations (our model) and (c) late fusion; (d) Example from a publicly available data set (e.g., 50salads) highlighting shared and private information that can be extracted from video and accelerometer data. While both modalities can detect the activation of relevant tools and common motion cues, RGB videos additionally capture fundamental details about objects without acceleration sensors and their state (e.g., chopped tomatoes), the overall spatial configuration and the localization of motion in the scene. Accelerometer signals, on the other hand, contain explicit and complementary information about 3D fine motion patterns of activated objects and their co-occurrence. In the presence of noise (e.g., video occlusions) or other variability factors, some shared attributes could become part of the private space of the uncorrupted modality.

Some actions are captured in data representing only one modality, e.g., video data captured by video sensors. Some actions are captured in data representing only another modality accelerometer data, e.g., movement that is away from the video sensors. Some are captured in data representing both modalities, e.g., a video that captures movement also recorded by the accelerometers. Actions in data streams observable by a single modality are considered private and actions in data streams observable by all modalities are considered shared.

Known studies on action segmentation classify video frames using temporal convolutional networks, that capture multi-scale temporal dependencies in the data through temporal pooling layers and/or dilated convolutions. While performing well in frame-wise accuracy, over-segmentation errors are very common among models designed to predict one action class for each frame. Different strategies were devised to alleviate this issue, from auxiliary smoothing losses to self-supervised domain adaptation techniques, prediction refinement modules, and postprocessing strategies. In contrast, graph-based models attempt to directly regularize model predictions by explicitly modelling contextual relations between successive actions.

Known studies have shown the potential of the attention mechanism in capturing long-range temporal dependencies in long video sequences. ASFormer, for example, uses sliding-window attention to reduce complexity of transformers and integrates it with temporal convolutions. Predictions can be refined with different types of attention-based decoders. The disclosed model efficiently fuses multiple data sources in long range action segmentation models and can use ASFormer as the backbone model. The proposed meth-odology can be integrated with arbitrary decoders, refinement modules or post-processing strategies to improve final predictions.

While several known action segmentation studies use features from multiple data sources, many relied on native merging strategies such as early concatenation of RGB and flow features. Alternatively, multimodal fusion was elaborated at the video encoding level, failing to capture common longer-range temporal dependencies among data sources.

Modality fusion has been utilized for action classification, i.e., the task of labelling trimmed action clips. CNNs rely on strong architectural priors that are often modality-specific, offering limited flexibility to data fusion and leading to a variety of customized schemes that need to be re-adapted to each application and dataset. More flexible fusion strategies rely on weighted blending of supervision signals in multistream systems.

Transformers, representing flexible perceptual models, may be able to handle a wide range of data sources with minimal changes to the model structure. The self-attention operation in transformers represents a straight-forward solution to combine different signals, but it does not account for information redundancy and it does not scale well to longer temporal sequences. To mitigate these issues, a known solution introduced ‘attention bottleneck’ to restrict the attention flow between tokens from different data sources and force each modality to share only what is necessary with the other modalities. The disclosed model explicitly separates modality-shared and private feature representations in a long-range action segmentation model and exploits the bottleneck mechanism to preserve feature disentanglement in subsequent temporal processing layers.

Shared and private feature disentanglement was explored in a Domain Separation Network (DNS) for unsupervised domain adaptation. DNS uses a shared-weight encoder to capture domain-shared features for a given input sample, and a private encoder for each domain to capture domain-specific attributes. To generate such disentangled representations and avoid trivial solutions, auxiliary losses are employed to bring shared representations close, while pushing them apart from the private features; a shared decoder is also employed to reconstruct input samples from their partitioned representations. The shared representation of the source domain is finally used to train the network on the task of interest.

The disclosed model differs from this work under multiple aspects: first, the disclosed model uses multimodal data rather than multi-domain images. This implies that mo-dality-specific feature representations could contain useful information for our downstream task and are considered also for prediction. Second, feature disentanglement is obtained by partitioning the latent space of each unimodal encoder, rather than building separate private and shared encoders, using an auxiliary similarity loss and a bottleneck mechanism, but no additional layers or auxiliary tasks. The disclosed solution allows information exchange at multiple abstraction levels while preserving disentanglement.

Known studies have used similar decompositions for different multimodal tasks, such as representation learning and cross-modal retrieval. These models are however based on probabilistic frameworks or generative adversarial networks, which are not trivial to train.

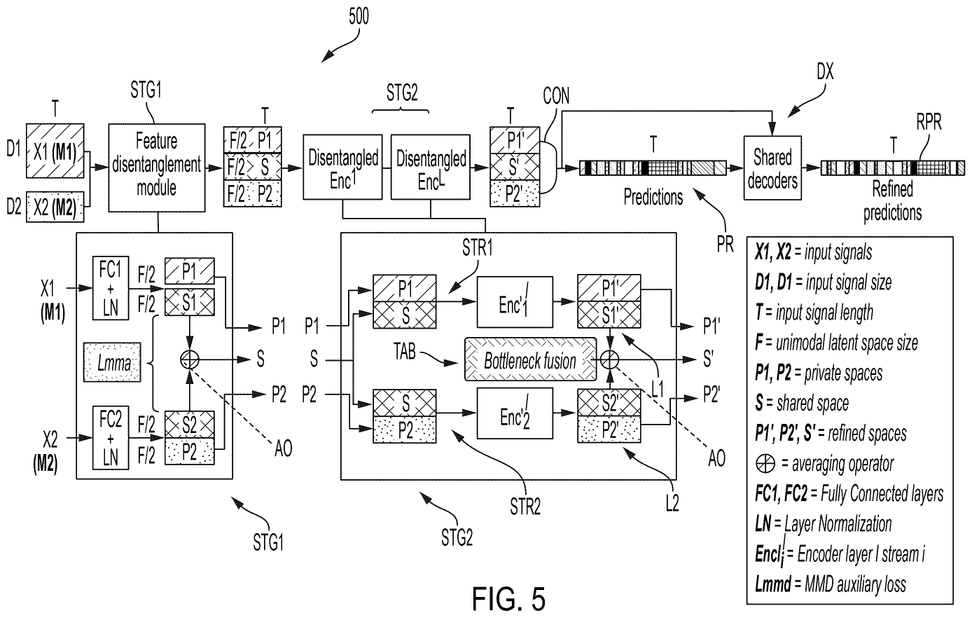

As discussed in greater detail below, FIG. 5 shows an ASPnet schematic 500. The modules introduced herein are illustrated in separate boxes. Frame-wise features from multiple data sources are first disentangled into modality-shared and private features. They then go through a sequence of L encoder layers with temporal attention bottleneck to generate frame-wise action predictions, later refined through multiple decoders.

The ASPnet schematic 500 is illustrated in FIG. 5 in the case of two input modalities. Pre-extracted frame-wise features from multiple data sources are disentangled into modality-shared and private spaces and then refined via temporal processing with a shared attention bottleneck to generate frame-wise action predictions.

The disclosed model, as depicted in the example of the ASPnet schematic 500 FIG. 5, partitions latent representations of multimodal or multiview networks into a shared space, containing common information across all sources, and a private space for each modality, such disentangled representations are more robust and facilitate action prediction. This is because shared knowledge can help abstraction from modality-specific details, while private spaces retain useful complementary knowledge.

The goal of the first stage STG1 of ASPnet is to obtain separated shared and private representations of the input signals Xi from the respective data sources, corresponding with the respective modalities Mi (e.g., video and accelerometer data). Given N synchronized input sequences Xi of length T and size Di, i=1: N, the disclosed model projects them into low dimensional features of size F via independent fully connected layers FCi followed by normalization layers. The disclosed model then partitions the latent space of each modality into private and shared spaces (Pi, Si) of size F/2. To effectively make all Si features contain shared information across data sources, the Maximum Mean Discrepancy (MMD) between all Si pairs is minimized during training:

$${L}_{mmd} = {\sum }_{i = 1}^{N - 1} {\sum }_{j = i + 1}^{N} MMD ( {S}_{i} , {S}_{j} ) . \qquad ( 1 )$$

Where Lmmd is the MMD auxiliary loss. At the end of this stage, an averaging operator AO is applied to the shared space data Si to obtain an average data S as an output of the first stage.

The goal of the second stage STG2 of ASPnet is to process the disentangled feature sequences from the first stage and generate frame-wise action predictions PR. The disclosed solution consists of a multi-stream segmentation model, one stream STRi for each data source. As our focus is to optimize information fusion, the disclosed aspects utilize the encoder (Enc) of a segmentation model, ASFormer, as the backbone of all ASPnet streams.

To preserve feature disentanglement in consecutive encoder layers Enc^{l}, which con-sist of one layer replica Enc^{l}i for each data source (each STRi is composed of all layer replicas Enc^{l}i, l∈{1, . . . , L}, for data source i), the disclosed model utilizes a temporal attention bottleneck TAB into the disclosed multi-stream architecture. The bottleneck is shared among all modalities Mi, according to known operations, and the bottleneck of the first encoder layer Enc¹ is initialized by the average S of the shared spaces Si generated in the first ASPnet stage. At each encoder layer Enc¹, 1∈{1, . . . , L}, shared(S) and private (Pi) features are processed independently for each modality Mi, and all the refined shared spaces S′i are then averaged again via an averaging operator AO:

$${P}_{i}^{′} , {S}_{i}^{′} = {Enc}_{i}^{l} \{ {P}_{i} , S ) , \qquad ( 2 )$$

$${S}^{′} = \frac{1}{N} {\sum }_{i = 1}^{N} {S}_{i}^{′} , \qquad ( 3 )$$

where S′ is the refined bottleneck and P′i is the refined private space of modality Mi. The concatenation CON of the shared bottleneck and all private spaces in the last encoder layer Enc^{L} is used to generate action predictions PR, later obtaining refined predictions RPR with multiple ASFormer decoders DX and moving-average post-processing.

The loss function L is a combination of cross-entropy classification loss (Lce) and smooth loss (Lsm) computed at the encoder (p=0), during STG2, and decoder (p=1: D) prediction stage. In addition, the disclosed aspects utilize the auxiliary MMD loss (Lmmd) for feature disentanglement:

$$L = γ {L}_{mmd} + {\sum }_{p = 0}^{D} ( {L}_{ce} ( p ) + λ {L}_{sm} ( p ) ) , \qquad ( 4 )$$

D is the number of decoder stages, λ and γ are loss weights.

To optimize data fusion, the disclosed model used the same set of model and training hyperparameters as ASFormer. The final model can include N encoder streams, where N is the number of available data sources, and one common 3-stage decoder. Each encoder stream and decoder stage can contain 10 attention layers with feature size=64 (shared feature size=private feature size=32, for example). As an example, a smooth loss weight 2 can be 0.25. For MMD, the disclosed model can use multiscale kernels with bandwidth range such as [0.2, 0.5, 0.9, 1.3], for instance. For the disclosed model, γ can be set to 1 without tuning. On one example data set, 50salads, the disclosed model can be trained for 100 epochs using Adam optimizer and learning rate 0.0005, for instance. On another data set, Breakfast, the disclosed model can be trained for 100 epochs with learning rate 0.0001, for example. Predictions can be post-processed with a moving average filter of 7 seconds in 50salads and 2 seconds in Breakfast, with grid-search performed on a range from 1 to 10 seconds, for example.

On another example dataset, RARP45, ASPnet can be tuned on a separate valida-tion set, and then the disclosed model can be re-trained on the full train set with the chosen hyperparameters. The number of layers of the disclosed model can be optimized (for example, set to 8, with search in [10, 9, 8, 7]), initial learning rate (for example, set to 0.0005, with search in [0.0005, 0.0001], number of training epochs (set to 50) and smoothing window size (set to 3 seconds, with grid-search in the range 1 to 5 seconds), as further examples. The other parameters can remain the same.

For development purposed, as one example, ASPnet can be implemented in PyTorch and trained on a system such as, NVIDIA Tesla V100. Optical flow features, if not already available, can be extracted from RAFT. flow frames using I3D pre-trained on Kinetics with window size=9, for instance.

ASPnet was benchmarked on challenging action segmentation datasets and ablation studies were performed.

Table 1 illustrates a comparison of multimodal ASPnet and different unimodal and fusion baselines on 50salads. MA=moving average.

TABLE 1

| | F1₅₀ | F1₂₅ | F1₁₀ | Acc | Edit | #Param(M) |
|---|---|---|---|---|---|---|
| ASFormer accel | 58.4 | 66.7 | 69.1 | 66.0 | 66.5 | 1.01 |
| ASFormer video | 76.3 | 83.1 | 84.8 | 86.2 | 80.0 | 1.13 |
| Late fusion | 71.9 | 79.0 | 80.7 | 85.4 | 73.2 | 2.14 |
| Early fusion | 78.9 | 84.6 | 86.0 | 88.4 | 79.7 | 1.14 |
| Mid fusion | 78.8 | 84.3 | 86.1 | 87.0 | 79.6 | 1.39 |
| ASPnet − Gaus | 79.1 | 85.3 | 86.5 | 87.4 | 80.6 | 1.33 |
| ASPnet − Eucl | 80.0 | 85.8 | 87.0 | 86.0 | 81.5 | 1.39 |
| ASPnet | 84.7 | 88.2 | 89.2 | 89.8 | 83.8 | 1.39 |
| ASPnet + MA | 85.6 | 89.5 | 90.4 | 89.8 | 85.6⁻ | 1.39 |

One example data set, the 50Salads dataset, contains 50 top-view videos of salad preparation activities performed by 25 different users in the same kitchen and is annotated with 19 action classes. It also contains 3-axis accelerometer signals of devices attached to the cooking tools and synchronization parameters for temporal alignment with the videos. In line with related work, evaluation on 50salads is performed at 15 Hz via 5-fold cross-validation and the average results are reported.

Another example data set, Breakfast, is a larger dataset containing 1712 videos of breakfast preparation activities recorded from multiple points of view in 18 different kitchens and annotated with 48 action classes. To compare with ASFormer, the disclosed model provided average results over 4 cross-validation folds, as one example.

Another example data set, RARP45, is an action segmentation dataset containing surgical activities extracted from 45 robot-assisted radical prostatectomies performed by 8 surgeons with different expertise, and it is annotated with 8 action classes. The data includes synchronized endoscopic videos and kinematic trajectories recorded from the robotic platform, but only the videos are publicly available. This dataset is challenging not only because it contains real-life activities in uncontrolled environment, but also because images are noisy (due to occlusions and specularities) and motion is analyzed at finer gran-ularity, so that action segmentation models must learn to discriminate subtle motion cues rather than the identity of the objects in use. Results on RARP45 are reported as average scores over the test videos.

For experiments on 50salads and Breakfast the disclosed model can use I3D features extracted from RGB and flow frames, unless stated otherwise. For RARP45, the same type of features can be extracted.

Segmentation performance by the disclose model can be analyzed using accuracy, edit distance and segmental F1-scores. Accuracy evaluates predictions in a frame-wise manner, but it is not able to assess temporal properties. The other scores measure the ability of a network to understand the structure of complex activities. While the edit distance only evaluates action ordering, the F1-scores additionally measure the temporal overlap between predicted and ground truth segments at different thresholds, such as: 10%, 25%, 50%.

Results with different input sources on 50salads. R=RGB, F=optical flow, A=accelerometer. +=concatenation are depicted in the example of table 2.

TABLE 2

| | F1₅₀ | F1₂₅ | F1₁₀ | Acc | Edit | #Param(M) |
|---|---|---|---|---|---|---|
| ASFormer (R + F) | 79.7 | 86.6 | 87.8 | 86.2 | 82.2 | 1.13 |
| ASPnet (R, F) | 80.9 | 86.8 | 88.6 | 87.2 | 82.7 | 1.39 |
| ASPnet (R + F, A) | 85.6 | 89.5 | 90.4 | 89.8 | 85.6 | 1.39 |
| ASPnet (R, F, A) | 86.4 | 90.4 | 91.3 | 90.3 | 85.8 | 1.64 |

Testing the contribution of learned shared-private features towards prediction performance via feature masking is illustrated in the example of table 3.

TABLE 3

| | F1₅₀ | F1₂₅ | F1₁₀ | Acc | Edit |
|---|---|---|---|---|---|
| Mask private | 74.6 | 81.8 | 83.0 | 82.2 | 76.3 |
| Mask shared | 79.2 | 84.9 | 86.5 | 85.4 | 80.6 |
| No mask | 85.6 | 89.5 | 90.4 | 89.8 | 85.6 |

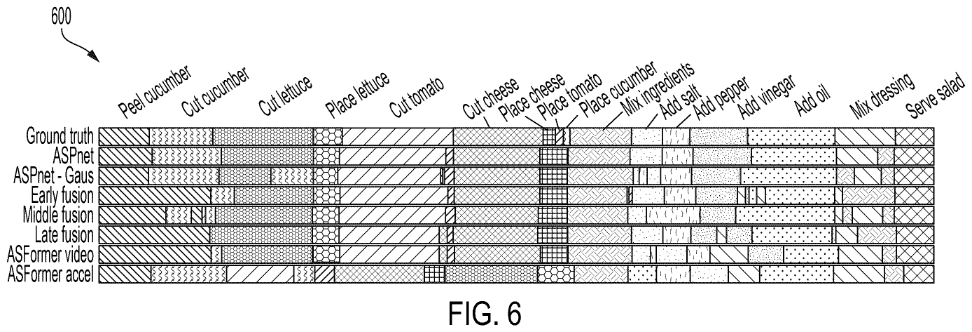

The ability was tested of ASPnet to fuse multimodal data using the video and accelerometer signals contained in 50salads (Table 1) in one example. The disclosed model outperforms all unimodal baselines as well as three different modality fusion strategies: early fusion corresponds to the original ASFormer model, where multimodal features are concatenated; late fusion corresponds to parallel unimodal ASFormer streams with average output logits; middle fusion corresponds to parallel ASFormer encoders and a common ASFormer decoder, which is equivalent to ASPnet with zero-sized bottleneck. ASPnet-Gaus, a variant of the disclosed model, was also trained, where the attention bottleneck is initialized with a Gaussian with zero mean and standard deviation of 0.02, as an example. Modality-shared features can provide a more effective initialization (improvement ranging from +2.4% to +5.6% on different scores in some examples). Native moving-average post-processing can further increase the final segmental scores. Qualitative results on 50salads are shown in FIG. 6. As shown in the figure, ASPnet can exploit multimodal information better than other fusion baselines (the predicted segmentation boundaries are closer to the ground truth boundaries and classification errors are reduced) and improves upon video-based predictions despite the low predictive power of accelerometers alone.

Feature disentanglement can be checked against trivial solutions by testing ASPnet with a mask on either the bottleneck or the private features, for example. In both cases a moderate drop in prediction performance may be observed, as illustrated in the example of Table 3, indicating that both representations contain useful information and are needed for action segmentation.

As a further example, 2048-dimensional video features used in one or more previ-ous experiments can be extracted by using both RGB and optical flow video frames. This can support testing the ability of the disclosed model to fuse multiview data by separating those features. As illustrated in the example in Table 2, ASPnet can achieve slighlty better performance compared with the original ASFormer, that uses a simple concatenation of the same data views. However, improvement is less significant than the multimodal case; different sensors generally contain more complementary information than multiple views of the same source, explaining why modality-shared and modality-specific feature disentanglement can be more beneficial in multimodal case.

ASPnet has a flexible design that supports in principle an arbitrary number of input modalities. On 50salads, three-stream ASPnet using I3D RGB, I3D optical flow and accelerometer features outperformed all two-stream solutions (in the example of Table 2). ASPnet can generalize readily to multiple data sources, increasing its accuracy as the number of input sources grows.

In practice, two modifications can make ASPnet scalable to a large number of input sensors: first, all encoder streams can share weights, so that the network size becomes independent from the number of inputs. Table 4 shows only a moderate drop in performance (Table 4), showing that 3-stream ASPnet with shared weights can be used with reduced computational resources while still offering competitive performance as another example. T ASPnet size is comparable to ASFormer (1.13 M) and smaller than other less competitive models (ranging from 0.8 M to 19.2 M).

Computational scalability with multiple data streams is illustrated in the example of Table 4. ASPnet performance can be assessed when all encoders have shared weights and using a scalable variation of the MMD loss (Lmmd′).

TABLE 4

| | F1₅₀ | F1₂₅ | F1₁₀ | Acc | Edit | #Param(M) |
|---|---|---|---|---|---|---|
| Shared-\hat{L}_{mmd} | 85.5 | 89.4 | 90.9 | 89.6 | 85.7 | 1.15 |
| Shared | 85.6 | 89.6 | 91.0 | 89.6 | 85.7 | 1.15 |
| Non-shared | 86.4 | 90.4 | 91.3 | 90.3 | 85.8 | 1.64 |

The second modification is on the auxiliary loss. Instead of computing MMD between all pairs of modality-shared spaces, the disclosed model can compute MMD between each shared space and the corresponding average bottleneck (Lmmd′). This is not conven-ient with two modalities (the number of losses grows from 1 to 2), and it is irrelevant with three modalities (the number of losses is 3 in both cases), but it is efficient with more than three modalities. In the disclosed experiments with 3 data streams, recognition performance was not significantly affected by this design choice (Table 4).

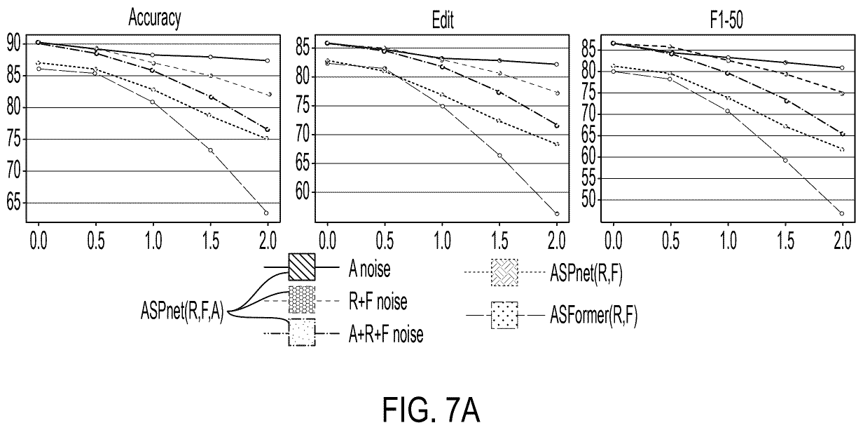

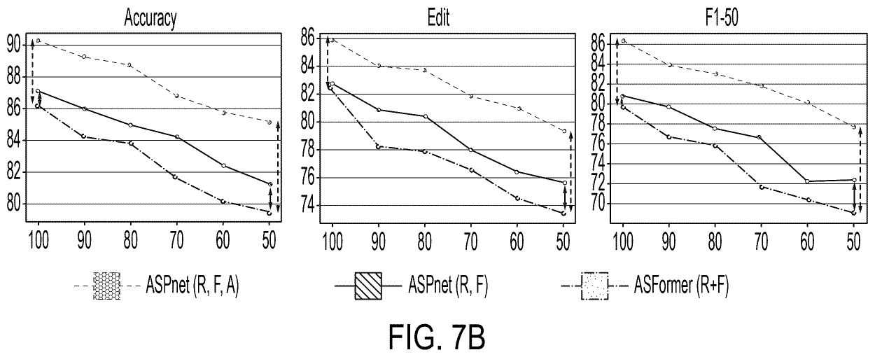

As discussed in greater detail below, FIG. 7(a) shows ASPnet robustness to noise. Multimodal ASPnet and multiview video ASPnet are compared with video ASFormer under different levels of additive zero-mean Gaussian noise (x-axis denotes noise standard deviation). Multimodal ASPnet is tested with acceleration noise, video noise and both. FIG. 7(b) shows the impact of reducing the training set size on different models. The x-axis shows the amount of training data in percentage. Vertical double arrows highlight performance gap between the disclosed models and ASFormer, which tends to increase as the number of training sequences decreases. F1-25 and F1-10 scores follow a trend similar to other evaluation scores in both experiments. R=RGB, F=flow, A=accelerometer. +=feature concatenation.

Improved prediction performance is not the only potential advantage of multimodal data fusion. Multiple data sources generally contain complementary information and are subject to different types of noise. When one modality is corrupted or insufficient to discriminate a certain action, the other modalities could compensate and rectify the model predictions.

Analysis of model robustness to different levels of additive zero-mean Gaussian noise (standard deviation s∈[0.5, 1, 1.5, 2], corresponding to about [10, 20, 30, 40] % of the input feature range, as an example) is presented in FIG. 7(a). Results are reported as average crossvalidation scores over 5 testing runs using different instances of the same random noise. Compared with video ASFormer, 3-stream ASPnet shows significantly reduced sensitivity to data corruption, whether on the video or both modalities. Moreover, ASPnet with corrupted accelerometer signals still outperforms ASFormer on original uncorrupted videos. Accelerometer signals in 50salads are very compact and easy to process, but insufficient to discriminate all action classes (as shown in Table 1 and FIG. 6). ASPnet thus strongly relies on the visual features and is more sensitive to video noise than accelerometer noise; however, the complementary motion information from the accelerometers is exploited effectively to improve prediction performance and make ASPnet remarkably more robust to video noise than the corresponding video baseline (the performance drop of ASPnet from uncorrupted inputs is about 50% smaller than ASFormer when s=1, and this gap increases with stronger noise).

Although in multiview scenarios the disclosed aspects cannot take advantage of a clean input when the other one is corrupted because all inputs derive from the same source, we observed that video ASFormer is notably more sensitive to noise than multiview video ASPnet based on the same input features, highlighting another advantage of the proposed feature disentanglement strategy.

Another potential gain when using richer data representations such as multiple sensors or views can be the ability to reach competitive performance with a reduced number of training videos, and therefore reduced annotation effort and costs. FIG. 7(b) shows prediction scores of multimodal ASPnet, multiview ASPnet and video ASFormer trained with decreasing amounts of data. Both multimodal and multiview ASPnets show smaller performance drops than ASFormer. In addition, multiview ASPnet trained with 50% of the videos outperforms video ASFormer trained with 70% of the videos and the same input features. Similar but amplified trend is observed for multimodal ASPnet, matching the performance of video ASFormer using only 70% of the training data, and outperforming video ASFormer trained with 90% of the videos using only 50%, as an example.

On 50salads, I3D features have been replaced with stronger video representations (Br-Prompt) aimed at improving ASFormer results (Br-Prompt+ASFormer), an another example. Br-Prompt RGB features were used for comparison with SOTA methods on this dataset, together with I3D optical flow features and accelerometer data. As reported in Table 5, multiview video ASPnet outperforms the state-of-the-art in accuracy and gets close to or matches the top segmental scores. When adding the accelerometer signals, ASPnet outperforms the state-of-the-art in all the metrics but the edit score. The top ranking method is a graph-based model, which is well suited to learn sequences and avoid over-segmentation errors, thus achieving large edit scores.

TABLE 5
Results on 50 salads.

| | F1₅₀ | F1₂₅ | F1₁₀ | Acc | Edit |
|---|---|---|---|---|---|
| ASFormer | 76.0 | 83.4 | 85.1 | 85.6 | 79.6 |
| ASFormer + ASRF | 79.3 | 85.4 | 85.1 | 85.6 | 81.7 |
| CETnet | 80.1 | 86.5 | 87.6 | 86.9 | 81.7 |
| DPRN | 79.4 | 86.3 | 87.8 | 87.2 | 82.0 |
| UVAST | 81.7 | 87.6 | 89.1 | 87.4 | 83.9 |
| Br-Prompt + ASFormer | 81.3 | 87.8 | 89.2 | 88.1 | 83.8 |
| Semantic2Graph | 87.3 | 90.2 | 91.5 | 88.6 | 89.1 |
| Br-Prompt + ASPnet (R, F) | 86.0 | 90.3 | 91.2 | 90.4 | 86.0 |
| Br-Prompt + ASPnet (R, A) | 87.3 | 91.3 | 92.2 | 90.9 | 87.5 |
| Br-Prompt + ASPnet (R, F, A) | 88.5 | 91.6 | 92.7 | 91.4 | 87.5 |

R = RGB,
F = flow,
A = accelerometer.

Multiview RGB-flow ASPnet was tested on Breakfast (Table 6), which does not contain multimodal data, but is larger and more complex than 50salads. ASPnet proved again to be superior to video ASFormer in all the evaluation metrics, using the same input features and sharing most of the network structure. It also demonstrated to be competitive with the state-of-the-art. CETnet differs from ASFormer only in the decoder stage, which is much larger (100 layers in CETnet as opposed to 30 in ASFormer), so ASPnet could be readily integrated into CETnet to potentially improve the prediction scores on larger datasets, such as Breakfast, for example. There could be room for improvement with system-atic hyperparameter search, smoothing losses or refinement stages.

TABLE 6
Results on Breakfast.

| | F1₅₀ | F1₂₅ | F1₁₀ | Acc | Edit |
|---|---|---|---|---|---|
| ASFormer | 57.4 | 70.6 | 76.0 | 73.5 | 75.0 |
| EUT | 59.8 | 71.8 | 76.2 | 75.0 | 74.6 |
| C2F-TCN | 57.6 | 68.7 | 72.2 | 76.0 | 69.6 |
| CETnet | 61.9 | 74.3 | 79.3 | 74.9 | 77.8 |
| ASPnet | 60.8 | 72.9 | 78.1 | 75.9 | 76.3 |

TABLE 7
Results on RARP45.

| | F1₅₀ | F1₂₅ | F1₁₀ | Acc | Edit |
|---|---|---|---|---|---|
| MA-TCN | — | — | 83.7 | 80.9 | 79.6 |
| ASPnet | 74.8 | 84.0 | 86.7 | 82.7 | 79.8 |

Multiview RGB-flow ASPnet was tested on RARP45 (Table 7), investigating the ability of the disclosed model to work in a different data domain. While using only video derived information, the disclosed model outperformed the state-of-the-art method fusing video and robot kinematics. This result shows that the disclosed model could be used in a wide range surgical procedures where robot kinematics is not available, such as traditional laparoscopy and endoscopy. Kinematic information could potentially be replaced also with compact surgical tool representations automatically extracted from surgical videos using pre-trained object and key-point detection models.

Variations of ASPnet architecture were tested. For example, the attention bottleneck was extended to the decoder stage, in all or part of its layers, but no significant improvement was observed. The role of the decoder is to refine the encoder predictions, improving specially the segmental scores. If such refinement is performed separately for each stream, the model could overfit individual modalities rather than achieve effective data fusion.

Different types of attention layers were also experimented with. While attention bottlenecks were originally applied on spatio-temporal tokens extracted from short video clips, full spatio-temporal self-attention is not tractable with long video sequences. The computation, however, can be decomposed into a temporal dimension, that is the dimension regarded in ASPnet, and a spatial dimension to capture complementary relations among all features at the same timestamp. Additional spatial-attention layers with attention bottleneck were thus introduced into ASPnet. These were integrated in the encoder or in the full disclosed model, sequentially or interlaced with the temporal-attention modules, but relevant gain in performance was not obtained. Replacing all temporal-attention layers with spatial-attention, the model reaches about 80% accuracy, but significantly lower segmental scores (e.g. less than 5% edit score) on split 1 of 50salads. This indicates that useful information can be captured via spatial self-attention, but it is challenging to integrate it optimally into long-range temporal models where temporal regularity is fundamental. Spatial attention could also give insight on which features and modalities the model focuses on at each timestamp.

In this disclosure, the problem of automatic action segmentation using multiple data sources is addressed. ASPnet is presented, which is a flexible model to fuse multiple inputs while simultaneously capturing long-range temporal dynamics in sequential data. Despite requiring synchronized recordings from multiple sensors, which might not always be possible, or time-consuming data processing to generate multiple input views, ASPnet has advantages over strong baselines, including higher recognition performance, reduced sensitivity to input noise and smaller training sets. The latter could have a large impact in reducing annotation efforts and costs, data storage requirements (when the other modalities are low-dimensional such as accelerometers, lidars, robot kinematics, etc.), as well as training time, mitigating the model environmental impact.

While showing similar advantages, multiview ASPnet achieves only a marginal performance gain compared with multimodal ASPnet. In the case of optical flow, the amount of information that is complementary to RGB features is more limited than, for example, 3D acceleration trajectories of multiple objects. Thus RGB-flow fusion will benefit less from the disentanglement of modality-shared and private feature representations. Future work will be aimed at evaluating ASPnet on alternative views of the video frames, such as human skeletons automatically identified in the scene.

Improvement in prediction performance could also be achieved by tuning the rela-tive size of shared and private latent spaces for every combination of inputs.

Large-scale action detection datasets such as Epic-Kitchens-100 and EGTEA include multiple synchronized data sources such as RGB, accelerometer, audio and gaze signals, and constitute further benchmarks to compare data fusion strategies.

Action segmentation represents a core step in a wide range of applications, including delicate tasks such as monitoring of surgical procedures. In this context, adversarial attacks could put patients' health at risk, especially with non-visual data sources such as robot kinematics, which are harder to inspect. While appropriate defense strategies should always be implemented, effective modality fusion is by itself a defense mechanism, making models more robust to input corruption.

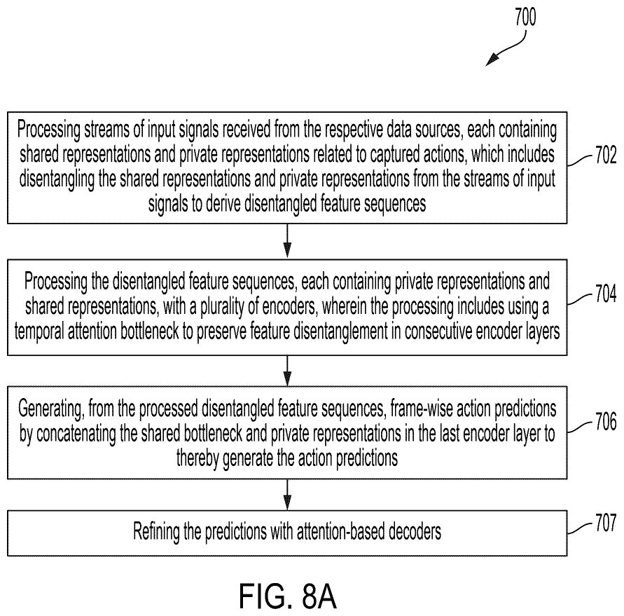

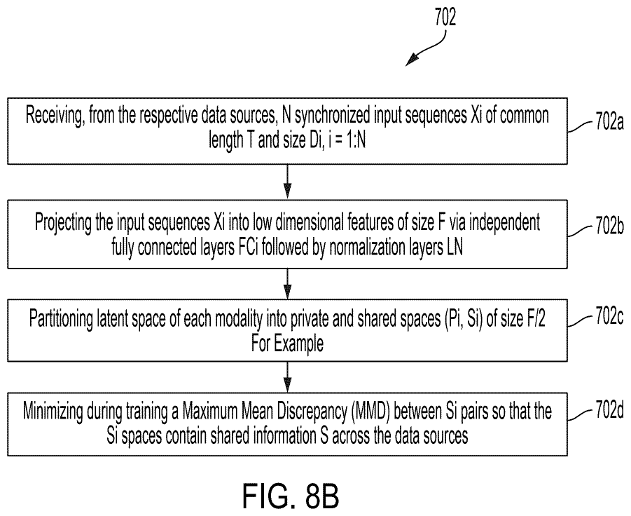

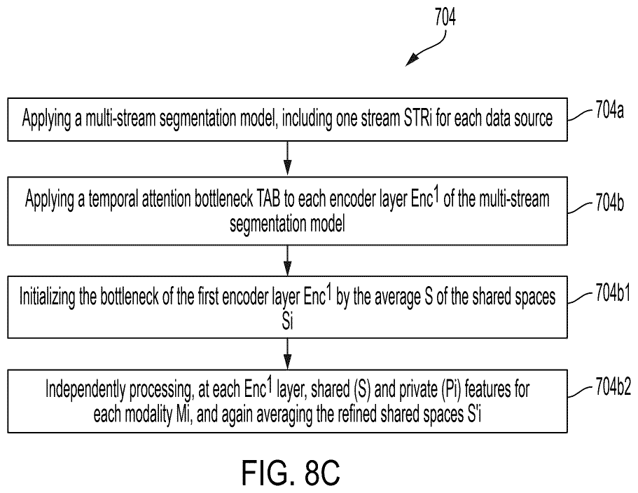

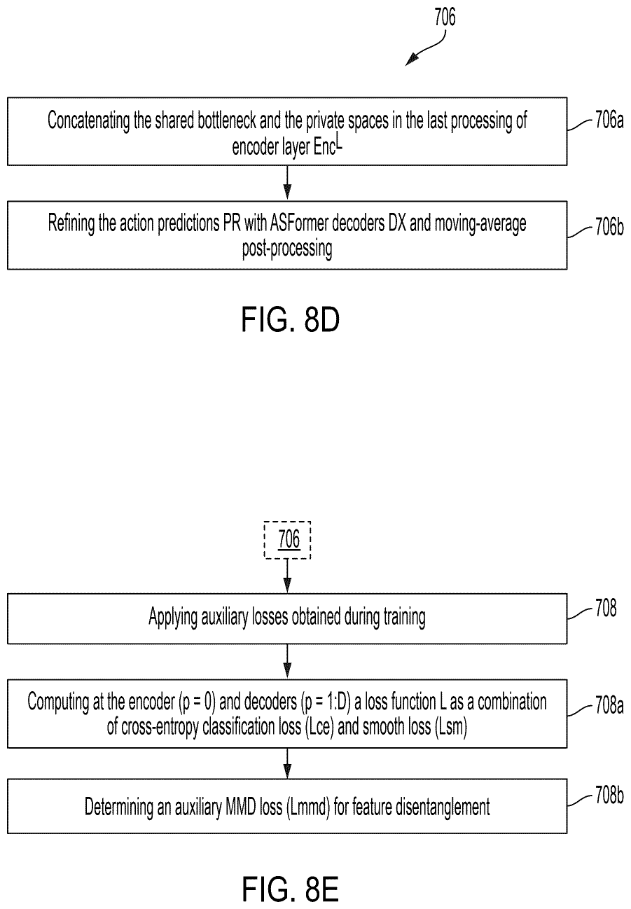

Turning now to FIG. 8a, a flowchart of a method 700 for partitioning latent representations of multimodal networks into a shared space containing common information across all data sources, and a private space for each of the modalities is generally shown in accordance with one or more aspects. All or a portion of method 700 can be implemented, for example, by all or a portion of CAS system 100 of FIG. 1 and/or computer system 800 of FIG. 9. At block 702 (e.g. a first stage STG1), the method includes processing streams of input signals received from the respective data sources, each containing shared representations and private representations related to captured actions. The processing at block 702 includes disentangling the shared representations and private representations from the streams of input signals to derive disentangled feature sequences.

At block 704 (e.g. a second stage STG2) the method includes processing the disentangled feature sequences with a plurality of encoders to derive a plurality of streams of representations, each containing the private representations and a combination of the shared representations. The processing at block 704 includes applying a temporal attention bottleneck into the plurality of streams, where the bottleneck is shared among the modalities to preserve feature disentanglement in consecutive encoder layers. At blocks 706 the method includes generating, from the processed disentangled feature sequences, frame-wise action predictions of contextual relations between successive actions, by concatenating the shared bottleneck and private representations in a last of the encoders to generate the action predictions. At block 707 the method includes refining the predictions with attention-based decoders.

Additional aspects of processing streams of input signals (block 702) are shown in FIG. 8b. As shown in block 702a, the method includes receiving, from the respective data sources, N synchronized input sequences Xi of common length T and size Di, i=1: N. As shown in block 702b, the method includes projecting the input sequences Xi into low dimensional features of size F via independent fully connected layers FCi followed by normalization layers LN. As shown in block 702c, the method includes partitioning latent space of each modality into private and shared spaces (Pi, Si) of size F/2. As shown in block 702d, the method includes minimizing during training a Maximum Mean Discrepancy (MMD) between Si pairs so that the Si spaces contain shared information across the data sources. At block 707, the method also includes generating an average value of the shared information S, which is then processed during execution of the second stage STG2.

Additional aspects of processing the disentangled feature sequences (e.g., the second stage) (block 704) are shown in FIG. 8c. As shown in block 704a, the method includes applying a multi-stream segmentation model, including one stream STRi for each data source. As shown in block 704b, the method includes applying a temporal attention bottleneck TAB to each encoder layer Enc^{l} of the multi-stream segmentation model. As shown in block 704b1, applying the temporal attention bottleneck TAB includes initializing the bottleneck of the first encoder layer Enc¹ by the average S of the shared spaces Si. As shown in block 704b2, applying the temporal attention bottleneck TAB includes independently processing, at each Enc/layer, shared(S) and private (Pi) features for each modality Mi, and again averaging the refined shared spaces S′i.

Additional aspects of generating frame-wise action predictions PR (block 706) are shown in FIG. 8d. As shown in block 706a, the method includes concatenating the shared bottleneck and the private spaces in the last encoder layer Enc^{l}, which are utilized for generating frame-wise action predictions. As shown in block 706b, the method includes refining the action predictions PR with ASFormer decoders DX and moving-average post-processing.

Turning to FIG. 8e, following block 706, the method includes block 708 of applying auxiliary losses. The rest of FIG. 8e shows additional aspects of applying auxiliary losses. As shown in block 708a, the method includes computing at the encoder (p=0) and decoders (p=1: D) a loss function L as a combination of cross-entropy classification loss (Lce) and smooth loss (Lsm). As shown in block 708b, the method includes determining an auxiliary MMD loss (Lmmd) for feature disentanglement.

The processing shown in FIGS. 8a-8e is not intended to indicate that the operations are to be executed in any particular order or that all of the operations shown in FIGS. 8a-8e are to be included in every case. Additionally, the processing shown in FIGS. 8a-8e can include any suitable number of additional operations.

Thus, according to an aspect of the disclosure, a computer-implemented method, of partitioning latent representations of multimodal networks into a shared space containing common information across data sources, and a private space for each of the modalities, includes: processing streams of input signals received from the respective data sources, each containing shared representations and private representations related to captured actions, which includes disentangling the shared representations and private representations from the streams of input signals to derive disentangled feature sequences; processing the disentangled feature sequences, each containing private representations and shared representations, with a plurality of encoders, wherein the processing includes using a temporal attention bottleneck to preserve feature disentanglement in consecutive encoder layers; generating, from the processed disentangled feature sequences, frame-wise action predictions by concatenating the shared bottleneck and private representations in the last encoder layer to thereby generate the action predictions; and refining the predictions with attention-based decoders.

According to another aspect of the disclosure, directed to the method, processing the streams of input signals includes: obtaining, from the respective data sources, N synchronized input sequences Xi of common length T and size Di,i=1: N; projecting the input sequences Xi into low dimensional features of size F via independent fully connected layers FCi followed by normalization layers LN; partitioning latent space of each modality into the private and shared spaces (Pi, Si) of size F/2 for example; and minimizing during training a Maximum Mean Discrepancy (MMD) between Si pairs so that the Si spaces contain shared information across the data sources, and determining an averaged shared information S from the shared spaces Si.

According to another aspect of the disclosure, directed to the method, an MMD auxiliary loss obtained during training is represented as

$${L}_{mmd} = {\sum }_{i = 1}^{N - 1} {\sum }_{j = i + 1}^{N} MMD ( {S}_{i} , {S}_{j} ) .$$

According to another aspect of the disclosure, directed to the method, processing the disentangled feature sequences includes: applying a multi-stream segmentation model, including one stream STRi for each data source, wherein the segmentation model includes at least one encoder layer Enc^{l}, which consists of one layer replica Enc^{l}i for each data source, wherein each STRi is composed of all layer replicas Enc^{l}i, l∈{1, . . . , L}, for data source i; and applying a temporal attention bottleneck TAB to each encoder layer Enc^{l} of the multi-stream segmentation model; and wherein the temporal attention bottleneck TAB is shared among the modalities Mi.

According to another aspect of the disclosure, directed to the method, applying temporal attention bottleneck TAB includes: initializing the bottleneck of a first encoder layer Enc¹ by the average S of the shared spaces Si; and independently processing, at each Enc^{l} layer, shared(S) and private (Pi) features for each modality Mi, and again averaging the refined shared spaces S′i according to:

$${P}_{i}^{′} , {S}_{i}^{′} = {Enc}_{i}^{l} ( {P}_{i} , S ) , {S}^{′} = \frac{1}{N} {\sum }_{i = 1}^{N} {S}_{i}^{′} ,$$

where S′ is the refined bottleneck and P′i is the refined private space of modality Mi.

According to another aspect of the disclosure, directed to the method, generating the action predictions PR includes: concatenating the shared bottleneck and the private spaces in the last processing of encoder layer Enc™; and refining the action predictions PR with decoders DX and moving-average post-processing.

According to another aspect of the disclosure, directed to the method, the method includes applying auxiliary losses obtained during training, which includes: computing at the encoder (p=0) and decoders (p=1: D) a loss function L as a combination of cross-entropy classification loss (Lce) and smooth loss (Lsm); and determining an auxiliary MMD loss (Lmmd) for feature disentanglement as:

$$L = γ {L}_{mmd} + {\sum }_{p = 0}^{D} ( {L}_{ce} ( p ) + λ {L}_{sm} ( p ) )$$

wherein D is a number of decoder stages, λ and γ are loss weights.

According to another aspect of the disclosure, a system includes a data store including video data associated with a surgical procedure; and a machine learning training system configured to partition latent representations of multimodal networks into a shared space containing common information across the data sources, and a private space for each of the modalities, the wherein the system is configured for executing operations, including: processing streams of input signals received from the respective data sources, each containing shared representations and private representations related to captured actions, which includes disentangling the shared representations and private representations from the streams of input signals to derive disentangled feature sequences; processing the disentangled feature sequences, each containing private representations and shared representations, with a plurality of encoders, wherein the processing includes using a temporal attention bottleneck to preserve feature disentanglement in consecutive encoder layers; generating, from the processed disentangled feature sequences, frame-wise action predictions; and refining the predictions with attention-based decoders.

According to another aspect of the disclosure, directed to the system, processing streams of input signals includes: receiving, from the respective data sources, N synchronized input sequences Xi of common length T and size Di, i=1: N; projecting the input sequences Xi into low dimensional features of size F via independent fully connected layers Fci followed by normalization layers LN; partitioning latent space of each modality into private and shared spaces (Pi, Si) of size F/2 for example; and minimizing during training a Maximum Mean Discrepancy (MMD) between Si pairs so that the Si spaces contain shared information S across the data sources; and determining an average shared information S from the shared spaces Si.

According to another aspect of the disclosure, directed to the system, an MMD auxiliary loss obtained during training is represented as

$${L}_{mmd} = {\sum }_{i = 1}^{N - 1} {\sum }_{j = i + 1}^{N} MMD ( {S}_{i} , {S}_{j} ) .$$

According to another aspect of the disclosure, directed to the system, processing the disentangled feature sequences includes: applying a multi-stream segmentation model, including one stream STRi for each data source, wherein the segmentation model includes at least one encoder layer Enc^{l}, which consists of one layer replica Enc^{l}i for each data source, each STRi is composed of all layer replicas Enc^{l}i, l∈{1, . . . , L}, for data source i; and applying a temporal attention bottleneck TAB to each encoder layer Enc^{l} of the multi-stream segmentation model; and wherein the temporal attention bottleneck TAB is shared among the modalities Mi.

According to another aspect of the disclosure, directed to the system, applying the temporal attention bottleneck TAB includes: initializing the bottleneck of a first encoder layer Enc¹ by the average S of the shared spaces Si; and independently processing, at each Enc^{l} layer, shared(S) and private (Pi) features for each modality Mi, and again averaging the refined shared spaces S′i according to:

$${P}_{i}^{′} , {S}_{i}^{′} = {Enc}_{i}^{l} ( {P}_{i} , S ) , {S}^{′} = \frac{1}{N} {\sum }_{i = 1}^{N} {S}_{i}^{′} ,$$

where S′ is the refined bottleneck and P′i i is the refined private space of modality Mi.

According to another aspect of the disclosure, directed to the system, generating the action predictions PR includes concatenating the shared bottleneck and the private spaces in the last processing of encoder layer Enc^{L}; and refining the action predictions PR with decoders DX and moving-average post-processing.

According to another aspect of the disclosure, directed to the system, the operations further include applying auxiliary losses obtained during training, which includes: computing at the encoder (p=0) and decoders (p=1: D) a loss function L as a combination of cross-entropy classification loss (Lce) and smooth loss (Lsm); and determining an auxiliary MMD loss (Lmmd) for feature disentanglement as:

$$L = γ {L}_{mmd} + {\sum }_{p = 0}^{D} ( {L}_{ce} ( p ) + λ {L}_{sm} ( p ) )$$

wherein D is a number of decoder stages, λ and γ are loss weights.

According to another aspect of the disclosure, a computer program product, having a memory device having computer executable instructions stored thereon, which when executed by one or more processors cause the one or more processors to perform a plurality of operations, including: partitioning latent representations of multimodal networks into a shared space containing common information across the data sources, and a private space for each of the modalities, the which includes: processing streams of input signals received from the respective data sources, each containing shared representations and private representations related to captured actions, which includes disentangling the shared representations and private representations from the streams of input signals to derive disentangled feature sequences; processing the disentangled feature sequences, each containing private representations and shared representations, with a plurality of encoders; generating, from the processed disentangled feature sequences, frame-wise action predictions; and refining the predictions with attention-based decoders.

According to another aspect of the disclosure, directed to the computer program product, processing streams of input signals includes: receiving, from the respective data sources, N synchronized input sequences Xi of common length T and size Di, i=1: N; projecting the input sequences Xi into low dimensional features of size F via independent fully connected layers FCi followed by normalization layers LN; and partitioning latent space of each modality into private and shared spaces (Pi, Si) of size F/2 for example; and minimizing during training a Maximum Mean Discrepancy (MMD) between Si pairs so that the Si spaces contain shared information across the data sources; and determining an average shared information S from the shared spaces Si.

According to another aspect of the disclosure, directed to the computer program product, an MMD auxiliary loss obtained during training is represented as

$${L}_{mmd} = {\sum }_{i = 1}^{N - 1} {\sum }_{j = i + 1}^{N} MMD ( {S}_{i} , {S}_{j} ) .$$

According to another aspect of the disclosure, directed to the computer program product, processing the disentangled feature sequences includes: applying a multi-stream segmentation model, including one stream STRi for each data source, wherein the segmentation model includes at least one encoder layer Enc^{l}, which consists of one layer replica Enc^{l}i for each data source, where each STRi is composed of all layer replicas Enc^{l}i, I E {1, . . . , L}, for data source i; and applying a temporal attention bottleneck TAB to each encoder layer Enc^{l} of the multi-stream segmentation model; and wherein the temporal attention bottleneck TAB is shared among the modalities Mi.

According to another aspect of the disclosure, directed to the computer program product, applying the temporal attention bottleneck TAB includes: initializing the bottleneck of a first encoder layer Enc¹ by the average S of the shared spaces Si; and independently processing, at each Enc^{l} layer, shared(S) and private (Pi) features for each mo-dality Mi, and again averaging the refined shared spaces S′i according to:

$${P}_{i}^{′} , {S}_{i}^{′} = {Enc}_{i}^{l} ( {P}_{i} , S ) , {S}^{′} = \frac{1}{N} {\sum }_{i = 1}^{N} {S}_{i}^{′} ,$$

where S′ is the refined bottleneck and P′i is the refined private space of modality Mi.

According to another aspect of the disclosure, directed to the computer program product, generating the action predictions PR includes concatenating the shared bottleneck and the private spaces in the last processing of encoder layer Enc^{L}; and refining the action predictions PR with decoders DX and moving-average post-processing.

Turning now to FIG. 9, a computer system 800 is generally shown in accordance with an aspect. The computer system 800 can be an electronic computer framework comprising and/or employing any number and combination of computing devices and networks utilizing various communication technologies, as described herein. The computer system 800 can be easily scalable, extensible, and modular, with the ability to change to different services or reconfigure some features independently of others. The computer system 800 may be, for example, a server, desktop computer, laptop computer, tablet computer, or smartphone. In some examples, computer system 800 may be a cloud computing node. Computer system 800 may be described in the general context of computer-executable instructions, such as program modules, being executed by a computer system. Generally, program modules may include routines, programs, objects, components, logic, data structures, and so on that perform particular tasks or implement particular abstract data types. Computer system 800 may be practiced in distributed cloud computing environments where tasks are performed by remote processing devices that are linked through a communications network. In a distributed cloud computing environment, program modules may be located in both local and remote computer system storage media, including memory storage devices.

As shown in FIG. 9, the computer system 800 has one or more central processing units (CPU(s)) 801a, 801b, 801c, etc. (collectively or generically referred to as processor(s) 801). The processors 801 can be a single-core processor, multi-core processor, computing cluster, or any number of other configurations. The processors 801 can be any type of circuitry capable of executing instructions. The processors 801, also referred to as processing circuits, are coupled via a system bus 802 to a system memory 803 and various other components. The system memory 803 can include one or more memory devices, such as read-only memory (ROM) 804 and a random-access memory (RAM) 805. The ROM 804 is coupled to the system bus 802 and may include a basic input/output system (BIOS), which controls certain basic functions of the computer system 800. The RAM is read-write memory coupled to the system bus 802 for use by the processors 801. The system memory 803 provides temporary memory space for operations of said instructions during operation. The system memory 803 can include random access memory (RAM), read-only memory, flash memory, or any other suitable memory systems.

The computer system 800 comprises an input/output (I/O) adapter 806 and a communications adapter 807 coupled to the system bus 802. The I/O adapter 806 may be a small computer system interface (SCSI) adapter that communicates with a hard disk 808 and/or any other similar component. The I/O adapter 806 and the hard disk 808 are collectively referred to herein as a mass storage 810.

Software 811 for execution on the computer system 800 may be stored in the mass storage 810. The mass storage 810 is an example of a tangible storage medium readable by the processors 801, where the software 811 is stored as instructions for execution by the processors 801 to cause the computer system 800 to operate, such as is described hereinbelow with respect to the various Figures. Examples of computer program product and the execution of such instruction is discussed herein in more detail. The communications adapter 807 interconnects the system bus 802 with a network 812, which may be an outside network, enabling the computer system 800 to communicate with other such systems. In one aspect, a portion of the system memory 803 and the mass storage 810 collectively store an operating system, which may be any appropriate operating system to coordinate the functions of the various components shown in FIG. 9.

Additional input/output devices are shown as connected to the system bus 802 via a display adapter 815 and an interface adapter 816. In one aspect, the adapters 806, 807, 815, and 816 may be connected to one or more I/O buses that are connected to the system bus 802 via an intermediate bus bridge (not shown). A display 819 (e.g., a screen or a display monitor) is connected to the system bus 802 by a display adapter 815, which may include a graphics controller to improve the performance of graphics-intensive applications and a video controller. A keyboard, a mouse, a touchscreen, one or more buttons, a speaker, etc., can be interconnected to the system bus 802 via the interface adapter 816, which may include, for example, a Super I/O chip integrating multiple device adapters into a single integrated circuit. Suitable I/O buses for connecting peripheral devices such as hard disk controllers, network adapters, and graphics adapters typically include common protocols, such as the Peripheral Component Interconnect (PCI). Thus, as configured in FIG. 8, the computer system 800 includes processing capability in the form of the processors 801, and storage capability including the system memory 803 and the mass storage 810, input means such as the buttons, touchscreen, and output capability including the speaker 823 and the display 819.

In some aspects, the communications adapter 807 can transmit data using any suitable interface or protocol, such as the internet small computer system interface, among others. The network 812 may be a cellular network, a radio network, a wide area network (WAN), a local area network (LAN), or the Internet, among others. An external computing device may connect to the computer system 800 through the network 812. In some examples, an external computing device may be an external web server or a cloud computing node.

It is to be understood that the block diagram of FIG. 9 is not intended to indicate that the computer system 800 is to include all of the components shown in FIG. 9. Rather, the computer system 800 can include any appropriate fewer or additional components not illustrated in FIG. 9 (e.g., additional memory components, embedded controllers, modules, additional network interfaces, etc.). Further, the aspects described herein with respect to computer system 800 may be implemented with any appropriate logic, wherein the logic, as referred to herein, can include any suitable hardware (e.g., a processor, an embedded controller, or an application-specific integrated circuit, among others), software (e.g., an application, among others), firmware, or any suitable combination of hardware, software, and firmware, in various aspects. Various aspects can be combined to include two or more of the aspects described herein.

Aspects disclosed herein may be a system, a method, and/or a computer program product at any possible technical detail level of integration. The computer program product may include a computer-readable storage medium (or media) having computer-readable program instructions thereon for causing a processor to carry out various aspects.

The computer-readable storage medium can be a tangible device that can retain and store instructions for use by an instruction execution device. The computer-readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer-readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device, such as punch-cards or raised structures in a groove having instructions recorded thereon, and any suitable combination of the foregoing. A computer-readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer-readable program instructions described herein can be downloaded to respective computing/processing devices from a computer-readable storage medium or to an external computer or external storage device via a network, for example, the Internet, a local area network, a wide area network, and/or a wireless network. The network may comprise copper transmission cables, optical transmission fibers, wireless transmission, routers, firewalls, switches, gateway computers, and/or edge servers. A network adapter card or network interface in each computing/processing device receives computer-readable program instructions from the network and forwards the computer-readable program instructions for storage in a computer-readable storage medium within the respective computing/processing device.

Computer-readable program instructions for carrying out operations of the present disclosure may be assembler instructions, instruction-set-architecture (ISA) instructions, machine instructions, machine-dependent instructions, microcode, firmware instructions, state-setting data, configuration data for integrated circuitry, or either source-code or object code written in any combination of one or more programming languages, including an object-oriented programming language, such as Smalltalk, C++, high-level languages such as Python, or the like, and procedural programming languages, such as the “C” programming language or similar programming languages. The computer-readable program instructions may execute entirely on the user's computer, partly on the user's computer, as a stand-alone software package, partly on the user's computer and partly on a remote computer, or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some aspects, electronic circuitry including, for example, programmable logic circuitry, field-programmable gate arrays (FPGA), or programmable logic arrays (PLA) may execute the computer-readable program instruction by utilizing state information of the computer-readable program instructions to personalize the electronic circuitry, in order to perform aspects of the present disclosure.

Aspects are described herein with reference to flowchart illustrations and/or block diagrams of methods, apparatus (systems), and computer program products according to aspects of the disclosure. It will be understood that each block of the flowchart illustrations and/or block diagrams, and combinations of blocks in the flowchart illustrations and/or block diagrams, can be implemented by computer-readable program instructions.

These computer-readable program instructions may be provided to a processor of a computer system, or other programmable data processing apparatus to produce a machine, such that the instructions, which execute via the processor of the computer or other programmable data processing apparatus, create means for implementing the functions/acts specified in the flowchart and/or block diagram block or blocks. These computer-readable program instructions may also be stored in a computer-readable storage medium that can direct a computer, a programmable data processing apparatus, and/or other devices to function in a particular manner, such that the computer-readable storage medium having instructions stored therein comprises an article of manufacture including instructions which implement aspects of the function/act specified in the flowchart and/or block diagram block or blocks.

The computer-readable program instructions may also be loaded onto a computer, other programmable data processing apparatus, or other device to cause a series of operational steps to be performed on the computer, other programmable apparatus or other devices to produce a computer-implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various aspects. In this regard, each block in the flowchart or block diagrams may represent a module, segment, or portion of instructions, which comprises one or more executable instructions for implementing the specified logical function(s). In some alternative implementations, the functions noted in the blocks may occur out of the order noted in the Figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various aspects have been presented for purposes of illustration but are not intended to be exhaustive or limited to the aspects disclosed. Many modifications and variations will be apparent to those of ordinary skill in the art without departing from the scope and spirit of the described aspects. The terminology used herein was chosen to best explain the principles of the aspects, the practical application or technical improvement over technologies found in the marketplace, or to enable others of ordinary skill in the art to understand the aspects described herein.

Various aspects are described herein with reference to the related drawings. Alternative aspects can be devised without departing from the scope of this disclosure. Various connections and positional relationships (e.g., over, below, adjacent, etc.) are set forth between elements in the following description and in the drawings. These connections and/or positional relationships, unless specified otherwise, can be direct or indirect, and the present disclosure is not intended to be limiting in this respect. Accordingly, a coupling of entities can refer to either a direct or an indirect coupling, and a positional relationship between entities can be a direct or indirect positional relationship. Moreover, the various tasks and process steps described herein can be incorporated into a more comprehensive procedure or process having additional steps or functionality not described in detail herein.

The following definitions and abbreviations are to be used for the interpretation of the claims and the specification. As used herein, the terms “comprises,” “comprising,” “includes,” “including,” “has,” “having,” “contains,” or “containing,” or any other variation thereof are intended to cover a non-exclusive inclusion. For example, a composition, a mixture, process, method, article, or apparatus that comprises a list of elements is not necessarily limited to only those elements but can include other elements not expressly listed or inherent to such composition, mixture, process, method, article, or apparatus.

Additionally, the term “exemplary” is used herein to mean “serving as an example, instance or illustration.” Any aspect or design described herein as “exemplary” is not necessarily to be construed as preferred or advantageous over other aspects or designs. The terms “at least one” and “one or more” may be understood to include any integer number greater than or equal to one, i.e., one, two, three, four, etc. The terms “a plurality” may be understood to include any integer number greater than or equal to two, i.e., two, three, four, five, etc. The term “connection” may include both an indirect “connection” and a direct “connection.”

The terms “about,” “substantially,” “approximately,” and variations thereof are intended to include the degree of error associated with measurement of the particular quantity based upon the equipment available at the time of filing the application. For example, “about” can include a range of ±8% or 5%, or 2% of a given value.

For the sake of brevity, conventional techniques related to making and using aspects may or may not be described in detail herein. In particular, various aspects of computing systems and specific computer programs to implement the various technical features described herein are well known. Accordingly, in the interest of brevity, many conventional implementation details are only mentioned briefly herein or are omitted entirely without providing the well-known system and/or process details.

It should be understood that various aspects disclosed herein may be combined in different combinations than the combinations specifically presented in the description and accompanying drawings. It should also be understood that, depending on the example, certain acts or events of any of the processes or methods described herein may be performed in a different sequence, may be added, merged, or left out altogether (e.g., all described acts or events may not be necessary to carry out the techniques). In addition, while certain aspects of this disclosure are described as being performed by a single module or unit for purposes of clarity, it should be understood that the techniques of this disclosure may be performed by a combination of units or modules associated with, for example, a medical device.

In one or more examples, the described techniques may be implemented in hardware, software, firmware, or any combination thereof. If implemented in software, the functions may be stored as one or more instructions or code on a computer-readable medium and executed by a hardware-based processing unit. Computer-readable media may include non-transitory computer-readable media, which corresponds to a tangible medium, such as data storage media (e.g., RAM, ROM, EEPROM, flash memory, or any other medium that can be used to store desired program code in the form of instructions or data structures and that can be accessed by a computer).

Instructions may be executed by one or more processors, such as one or more digital signal processors (DSPs), graphics processing units (GPUs), microprocessors, application-specific integrated circuits (ASICs), field programmable logic arrays (FPGAs), or other equivalent integrated or discrete logic circuitry. Accordingly, the term “processor” as used herein may refer to any of the foregoing structure or any other physical structure suitable for implementation of the described techniques. Also, the techniques could be fully implemented in one or more circuits or logic elements.

1. A computer-implemented method of partitioning latent representations of multimodal networks into a shared space containing common information across data sources, and a private space for each of the modalities, the method comprising:
processing streams of input signals received from the respective data sources, each containing shared representations and private representations related to captured actions, which includes disentangling the shared representations and private representations from the streams of input signals to derive disentangled feature sequences;
processing the disentangled feature sequences, each containing private representations and shared representations, with a plurality of encoders, wherein the processing includes using a temporal attention bottleneck to preserve feature disentanglement in consecutive encoder layers;
generating, from the processed disentangled feature sequences, frame-wise action predictions by concatenating the shared bottleneck and private representations in the last encoder layer to thereby generate the action predictions; and
refining the predictions with attention-based decoders.

2. The method of claim 1, wherein processing the streams of input signals includes:
obtaining, from the respective data sources, N synchronized input sequences Xi of common length T and size Di, I=1: N;
projecting the input sequences Xi into low dimensional features of size F via independent fully connected layers FCi followed by normalization layers LN;
partitioning latent space of each modality into the private and shared spaces (Pi, Si) of size F/2; and
minimizing during training a Maximum Mean Discrepancy (MMD) between Si pairs so that the Si spaces contain shared information across the data sources, and
determining an averaged shared information S from the shared spaces Si.

3. The method of claim 2, wherein:
an MMD auxiliary loss obtained during training is represented as
$${L}_{mmd} = {\sum }_{i = 1}^{N - 1} {\sum }_{j = i + 1}^{N} MMD ( {S}_{i} , {S}_{j} ) .$$

4. The method of claim 2, wherein processing the disentangled feature sequences includes:
applying a multi-stream segmentation model, including one stream STRi for each data source,
wherein the segmentation model comprises at least one encoder layer Enc^{l}, which consists of one layer replica Enc^{l}i for each data source, wherein each STRi is composed of all layer replicas Enc^{l}i, l∈{1, . . . , L}, for data source i; and
applying a temporal attention bottleneck TAB to each encoder layer Enc^{l} of the multi-stream segmentation model; and
wherein the temporal attention bottleneck TAB is shared among the modalities Mi.

5. The method of claim 4, wherein applying temporal attention bottleneck TAB includes:
initializing the bottleneck of a first encoder layer Enc¹ by the average S of the shared spaces Si; and
independently processing, at each Enc^{l} layer, shared(S) and private (Pi) features for each modality Mi, and again averaging the refined shared spaces S′i according to:
$${P}_{i}^{′} , {S}_{i}^{′} = {Enc}_{i}^{l} ( {P}_{i} , S ) , {S}^{′} = \frac{1}{N} {\sum }_{i = 1}^{N} {S}_{i}^{′} ,$$
where S′ is the refined bottleneck and P′i is the refined private space of modality Mi.

6. The method of claim 5, wherein generating the action predictions PR includes:
concatenating the shared bottleneck and the private spaces in the last processing of encoder layer Enc^{L}; and
refining the action predictions PR with decoders DX and moving-average post-processing.

7. The method of claim 6, including applying auxiliary losses obtained during training, which includes:
computing at the encoder (p=0) and decoders (p=1: D) a loss function L as a combination of cross-entropy classification loss (Lce) and smooth loss (Lsm); and
determining an auxiliary MMD loss (Lmmd) for feature disentanglement as:
$$L = γ {L}_{mmd} + {\sum }_{p = 0}^{D} ( {L}_{ce} ( p ) + λ {L}_{sm} ( p ) )$$
wherein D is a number of decoder stages, λ and γ are loss weights.

8. A system comprising:
a data store comprising video data associated with a surgical procedure; and
a machine learning training system configured to partition latent representations of multimodal networks into a shared space containing common information across the data sources, and a private space for each of the modalities, the wherein the system is configured for executing operations, including:
processing streams of input signals received from the respective data sources, each containing shared representations and private representations related to captured actions, which includes disentangling the shared representations and private representations from the streams of input signals to derive disentangled feature sequences;
processing the disentangled feature sequences, each containing private representations and shared representations, with a plurality of encoders, wherein the processing includes using a temporal attention bottleneck to preserve feature disentanglement in consecutive encoder layers;
generating, from the processed disentangled feature sequences, frame-wise action predictions; and
refining the predictions with attention-based decoders.

9. The system of claim 8, wherein processing streams of input signals includes:
receiving, from the respective data sources, N synchronized input sequences Xi of common length T and size Di, i=1: N;
projecting the input sequences Xi into low dimensional features of size F via independent fully connected layers FCi followed by normalization layers LN;
partitioning latent space of each modality into private and shared spaces (Pi, Si) of size F/2; and
minimizing during training a Maximum Mean Discrepancy (MMD) between Si pairs so that the Si spaces contain shared information S across the data sources; and
determining an average shared information S from the shared spaces Si.

10. The system of claim 9, wherein:
an MMD auxiliary loss obtained during training is represented as
$${L}_{mmd} = {\sum }_{i = 1}^{N - 1} {\sum }_{j = i + 1}^{N} MMD ( {S}_{i} , {S}_{j} ) .$$

11. The system of claim 9, wherein processing the disentangled feature sequences includes:
applying a multi-stream segmentation model, including one stream STRi for each data source,
wherein the segmentation model comprises at least one encoder layer Enc^{l}, which consists of one layer replica Enc^{l}i for each data source, each STRi is composed of all layer replicas Enc^{l}i, l∈{1, . . . , L}, for data source i; and
applying a temporal attention bottleneck TAB to each encoder layer Enc^{l} of the multi-stream segmentation model; and
wherein the temporal attention bottleneck TAB is shared among the modalities Mi.

12. The system of claim 11, wherein applying the temporal attention bottleneck TAB includes:
initializing the bottleneck of a first encoder layer Enc¹ by the average S of the shared spaces Si; and
independently processing, at each Enc^{l} layer, shared(S) and private (Pi) features for each modality Mi, and again averaging the refined shared spaces S′i according to:
$${P}_{i}^{′} , {S}_{i}^{′} = {Enc}_{i}^{l} ( {P}_{i} , S ) , {S}^{′} = \frac{1}{N} {\sum }_{i = 1}^{N} {S}_{i}^{′} ,$$
where S′ is the refined bottleneck and P′i i is the refined private space of modality Mi.

13. The system of claim 12, wherein:
generating the action predictions PR includes concatenating the shared bottleneck and the private spaces in the last processing of encoder layer Enc^{L}; and
refining the action predictions PR with decoders DX and moving-average post-processing.

14. The system of claim 13, wherein the operations further include applying auxiliary losses obtained during training, which includes:
computing at the encoder (p=0) and decoders (p=1: D) a loss function L as a combination of cross-entropy classification loss (Lce) and smooth loss (Lsm); and
determining an auxiliary MMD loss (Lmmd) for feature disentanglement as:
$$L = γ {L}_{mmd} + {\sum }_{p = 0}^{D} ( {L}_{ce} ( p ) + λ {L}_{sm} ( p ) )$$
wherein D is a number of decoder stages, λ and γ are loss weights.

15. A computer program product comprising a memory device having computer executable instructions stored thereon, which when executed by one or more processors cause the one or more processors to perform a plurality of operations comprising:
partitioning latent representations of multimodal networks into a shared space containing common information across the data sources, and a private space for each of the modalities, the which includes:
processing streams of input signals received from the respective data sources, each containing shared representations and private representations related to captured actions, which includes disentangling the shared representations and private representations from the streams of input signals to derive disentangled feature sequences;
processing the disentangled feature sequences, each containing private representations and shared representations, with a plurality of encoders; generating, from the processed disentangled feature sequences, frame-wise action predictions; and
refining the predictions with attention-based decoders.

16. The computer program product of claim 15, wherein processing streams of input signals includes:
receiving, from the respective data sources, N synchronized input sequences Xi of common length T and size Di, i=1: N;
projecting the input sequences Xi into low dimensional features of size F via independent fully connected layers FCi followed by normalization layers LN; and
partitioning latent space of each modality into private and shared spaces (Pi, Si) of size F/2; and
minimizing during training a Maximum Mean Discrepancy (MMD) between Si pairs so that the Si spaces contain shared information across the data sources; and
determining an average shared information S from the shared spaces Si.

17. The computer program product of claim 16, wherein:
an MMD auxiliary loss obtained during training is represented as
$${L}_{mmd} = {\sum }_{i = 1}^{N - 1} {\sum }_{j = i + 1}^{N} MMD ( {S}_{i} , {S}_{j} ) .$$

18. The computer program product of claim 16, wherein processing the disentangled feature sequences includes:
applying a multi-stream segmentation model, including one stream STRi for each data source,
wherein the segmentation model comprises at least one encoder layer Enc^{l}, which consists of one layer replica Enc^{l}i for each data source, where each STRi is composed of all layer replicas Enc^{l}i, l∈{1, . . . , L}, for data source i; and
applying a temporal attention bottleneck TAB to each encoder layer Enc^{l} of the multi-stream segmentation model; and
wherein the temporal attention bottleneck TAB is shared among the modalities Mi.

19. The computer program product of claim 18, wherein:
applying the temporal attention bottleneck TAB includes:
initializing the bottleneck of a first encoder layer Enc¹ by the average S of the shared spaces Si; and
independently processing, at each Enc layer, shared(S) and private (Pi) features for each modality Mi, and again averaging the refined shared spaces S′i according to:
$${P}_{i}^{′} , {S}_{i}^{′} = {Enc}_{i}^{l} ( {P}_{i} , S ) , {S}^{′} = \frac{1}{N} {\sum }_{i = 1}^{N} {S}_{i}^{′} ,$$
where S′ is the refined bottleneck and P′i is the refined private space of modality Mi.

20. The computer program product of claim 19, wherein:
generating the action predictions PR includes concatenating the shared bottleneck and the private spaces in the last processing of encoder layer Enc^{L}; and
refining the action predictions PR with decoders DX and moving-average post-processing.
